(19) United States
(12) Patent Application Publication
(10) Pub. No.: US 2010/0045426 A1
(43) Pub. Date: Feb. 25, 2010

(54) INFORMATION COMMUNICATION SYSTEM, INFORMATION COMMUNICATION METHOD, INFORMATION COMMUNICATION APPARATUS AND RECORDING MEDIUM

(75) Inventors: Jun Kakuta, Kawasaki (JP); Satoshi Okuyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/609,853

(22) Filed: Oct. 30, 2009

Related U.S. Application Data
(63) Continuation of application No. PCT/JP2007/059486, filed on May 8, 2007.

(51) Int. Cl. G08B 5/22; G05B 19/00

(52) U.S. Cl. 340/5.21; 340/825.37

(57) ABSTRACT

An information communication system includes a first terminal apparatus which includes a notifying unit for notifying of presence information including status information of an object, a second terminal apparatus which includes a transmitting unit for transmitting a subscribe request of the presence information, and a central apparatus which includes a relay unit for relaying the first and second terminal apparatuses to each other; and a control unit capable of performing operations of determining whether or not a subscription of presence information by the second terminal apparatus is permitted, when the update of the presence information is received from the first terminal apparatus and providing the notification of the presence information to the second terminal apparatus to which the presence information is permitted to be notified.

### CROSS-REFERENCE TO RELATED APPLICATIONS

This application is a continuation, filed under 35 U.S.C. §111(a), of PCT international Application No. PCT/JP2007/059486, which has an international filing date of May 8, 2007, and designated the United States of America.

### FIELD

The present application relates to an information communication system in which various pieces of presence information such as status information, attribute information, and position information of an object such as a person or a thing are changed, the pieces of information are automatically notified from a central apparatus to an allowed terminal apparatus. In particular, the present invention relates to an information communication system, an information communication method, an information communication apparatus, and a recording medium which can appropriately perform a determination process for the status of the notification of presence information even though an object is a thing.

### BACKGROUND

In recent years, with progress of spreading of communication infrastructure, a communication apparatus can be always connected to a network. Thus, an information communication system called a presence system in which communication apparatuses can notify of information representing a situation such as the status of a person using a communication apparatus connected to the network to each other has been prevailed.

On the other hand, a sensor technology such as RFID (Radio Frequency Identification) which can automatically detect the status of a person or a thing by radio is prevailed. Since a presence system is good in real-time property the sensor technology is used to obtain a configuration in which information of the status of an object such as a person or a thing is notified between communication apparatuses, so that the sensor technology can also be applied to a logistics monitoring system which always remotely monitors status information of the object.

In the presence system, an object is called a presentity (presentity, see RFC2778). The presentity is a person, a thing, or the like. On the other hand, a communication apparatus issuing a subscribe request to request the notification of presence information of the presentity is called a watcher terminal apparatus, and a user using the watcher terminal apparatus is called a watcher. Furthermore, a communication apparatus which receives a subscribe request from the watcher terminal apparatus and relays the subscribe request to the presence terminal apparatus is called a presence server apparatus. A person who issues presence information of a presentity by updating the presence information, a sensor which detects and updates presence information of a presentity, or the like is called a publisher. When the presentity is a person, a publisher who issues her/his own presence information is the presentity herself/himself.

In the presence system, presence information must be notified to an intended watcher terminal apparatus to prevent the presence information from being disclosed to an unintended watcher. Therefore, the notification itself of the presence information or the contents of the presence information to be notified is desirably restricted. Therefore, a general presence system is configured such that a determination of the status of the notification of presence information is performed by a user herself/himself who is a presentity to notify of the presence information to only a watcher terminal apparatus which is allowed to be notified. More specifically, a subscribe request of presence information is transmitted from the watcher terminal apparatus, the subscribe request is transferred to a presence terminal apparatus which notifies of the presence information. A user who is a presentity using the presence terminal apparatus determines whether or not the subscription is permitted, and the result is transmitted from the presence terminal apparatus to the watcher terminal apparatus. When the subscription is permitted, presence information is notified to the watcher terminal apparatus upon the presence information being issued at a subsequent time. However, when the subscription is rejected, the presence information is not notified.

However, when the numbers of presentities and watchers increase to enlarge the presence system, in a configuration in which a user who is a presentity determines whether or not presence information is notified each time a subscribe request is transmitted from a watcher, a process of determining whether or not the subscription is permitted is very cumbersome.

Therefore, in a presence system disclosed in Japanese Patent Application Laid Open No. 2005-309500, when a subscription request from a watcher is accepted by a presence server, the presence server does not directly transmit the subscribe request to the presentity, and the presence server determines whether or not the subscription is permitted based on a policy stored depending on an attribute of a watcher serving as a communication request source. Since a presence server apparatus partially determines whether or not the subscription is permitted, lots of operations of determining whether or not the subscription is permitted is reduced, the operations being performed by a user using a presence terminal.

A presence system is originally developed to exchange presence information representing a status such as presence/absence information between users who are watchers. Therefore, it is assumed that determination whether or not the subscription is permitted is performed by a user who is a presentity using a presence terminal apparatus, and it is not considered that a main body of the presence information is a thing. Even in the technique disclosed in Japanese Patent Application Laid Open No. 2005-309500, a user is supposed as a presentity. The object thereof is to reduce a cumbersome process of a user for determining whether or not the notification is permitted.

In the technique disclosed in Japanese Patent Application Laid Open No. 2005-309500, when a presence serving apparatus determines whether or not the subscription is permitted, as information used as a reference for the determination, an attribute of a watcher is given. More specifically it is determined whether or not the subscription is permitted by checking a group to which a watcher belongs. However, when a presentity is a thing, depending on not only the attribute of the watcher but also an attribute of a publisher which issues presence information, for example, a position at which the publisher is present, it may have to be determined whether or not the information is notified.

In the technique disclosed in Japanese Patent Application Laid Open No. 2005-309500, at the time when a presence server apparatus receives a subscribe request of presence information, it is determined with reference to a policy whether or not the subscription is permitted. Therefore, when a subscribe request is transmitted to a predetermined terminal apparatus used by an administrator to perform an inquiry process of asking the administrator to perform determination of inquiry of whether or not the subscription is permitted, each time a subscribe request of presence information is received, the information is transmitted to the predetermined terminal apparatus. In this case, the process by the administrator for determining whether or not the subscription is permitted.

### SUMMARY

According to an aspect of the present application, an information communication system includes a first terminal apparatus which includes a notifying unit for notifying of presence information including status information of an object, a second terminal apparatus which includes a transmitting unit for transmitting a subscribe request of the presence information, and a central apparatus which includes a relay unit for relaying the first and second terminal apparatuses to each other; and a control unit capable of performing operations of determining whether or not a subscription of presence information by the second terminal apparatus is permitted, when the update of the presence information is received from the first terminal apparatus and providing the notification of the presence information to the second terminal apparatus to which the presence information is permitted to be notified.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an example diagram typically illustrating an outline of a configuration of an information communication system according to the embodiment;

FIG. 2 is a block diagram illustrating internal configurations of presence terminal apparatuses which constitute a presence system according to the embodiment;

FIG. 3 is a block diagram illustrating internal configurations of a presence server apparatus and a watcher terminal apparatus which constitute the information communication system according to the embodiment;

FIG. 4 is an example diagram illustrating a screen displayed on a display unit of the watcher terminal apparatus according to the embodiment;

FIG. 5 is an example diagram illustrating a screen displayed in formation of a group on the display unit of the watcher terminal apparatus according to the embodiment;

FIG. 6 is an example diagram illustrating a screen displayed in a presence information creating request on the display unit of the watcher terminal apparatus according to the embodiment;

FIG. 7 is a flow chart illustrating procedures of a creating process and a transmitting process for a subscribe request by a control unit of the watcher terminal apparatus according to the embodiment;

FIG. 8 is an example diagram illustrating a content of policy information stored in a storing unit of a presence server apparatus according to the embodiment;

FIG. 9 is an example diagram illustrating a content of an exception list stored in the storing unit of the presence server apparatus according the embodiment;

FIG. 10 is an example diagram illustrating a content of a buddy list stored in the storing unit of the presence server apparatus according to the embodiment;

FIG. 11 is an example diagram illustrating a content of a watcher list including permitted watcher list stored in the storing unit of the presence server apparatus according to the embodiment;

FIG. 12 is an example diagram illustrating a content of a content processing rule stored in the storing unit of the presence server apparatus according to the embodiment;

FIG. 13 is a flow chart illustrating a procedure in which the control unit of the presence server apparatus according to the embodiment determines whether or not the subscription is permitted with respect to a received the subscribe request;

FIG. 14 is an example diagram illustrating a content of a pending list stored in the storing unit by the control unit of the presence server apparatus according to the embodiment;

FIG. 15 is a flow chart illustrating a procedure in which the control unit of a presence terminal apparatus according to the embodiment detects that presence information of an object is issued by an input unit to notify of the presence information;

FIG. 16 is a flow chart illustrating a procedure in which the control unit of the presence server apparatus according to the embodiment determines whether or not the subscription is possible or whether or not an inquiry process is required when presence information is notified;

FIG. 17 is a flow chart illustrating a procedure in which the control unit of the presence server apparatus according to the embodiment determines whether or not the subscription is permitted or whether or not an inquiry process is required when presence information is notified;

FIG. 18 is a flow chart illustrating a procedure in which the control unit of the presence terminal apparatus according to the embodiment accepts determination whether or not the subscription is permitted depending on an inquiry from the presence server apparatus;

FIG. 19 is an example diagram illustrating a content of an inquiry screen displayed on the display unit of the presence terminal apparatus according to the embodiment;

FIG. 20 is an example diagram illustrating a screen displayed on the display unit of the presence terminal apparatus according to the embodiment;

FIG. 21 is a flow chart illustrating an overall outline of a procedure executed by the control unit of the presence server apparatus according to the embodiment based on selected permission/rejection of the notification;

FIG. 22 is a flow chart illustrating a procedure executed by the control unit of the presence server apparatus according to the embodiment when permission/rejection of the notification selected by the inquiry process is “permission from now”;

FIG. 23 is a flow chart illustrating a procedure executed by the control unit of the presence server apparatus according to the embodiment when projection/rejection of the notification selected by the inquiry process is “the same attribute is also permitted”;

FIG. 24 is a flow chart illustrating a procedure executed by the control unit of the presence server apparatus according to the embodiment when projection/rejection of the notification selected by the inquiry process is “also rejected from now”;

FIG. 25 is a flow chart illustrating a procedure executed by the control unit of the presence server apparatus according to the embodiment when projection/rejection of the notification selected by the inquiry process is “the same attribute is also rejected”;

FIG. 26 is an example diagram illustrating an example in which a subscribe request is added to an exception list of the storing unit of the presence server apparatus according to the embodiment; and

FIG. 27 is an example diagram illustrating an example in which a mark is set in a pending list of the storing unit of the presence server apparatus according to the embodiment.

### DESCRIPTION OF THE EMBODIMENT

The present invention will be concretely described below with reference to the drawings shown in the embodiments of the present invention.

The embodiment (will be described later) will be described by using an example in which an information communication system according to the present invention is applied to a logistics management system in which stages of arrival of articles, checkout, shipment, and the like are grasped and managed. In this case, a presentity of the information communication system is an object serving as an article. In the embodiment, presence information includes state information representing a situation of an object such as position information, process information, or the like of the object.

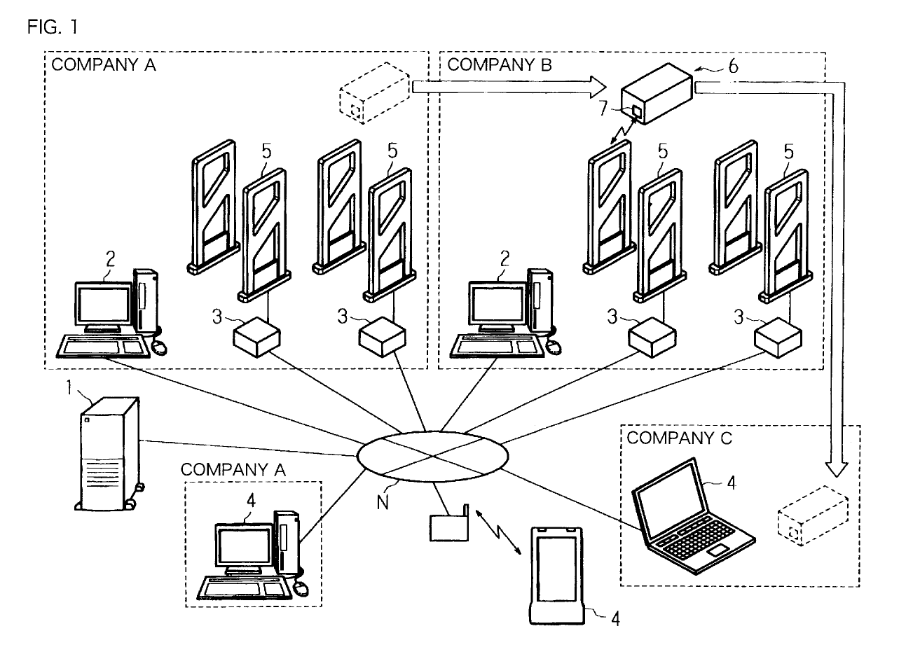

FIG. 1 is an example diagram typically illustrating an outline of a configuration of the information communication system according to the embodiment. The information communication system includes a presence server apparatus 1 connected to a network such as the Internet, a plurality of presence terminal apparatuses 2, 2, . . . and 3, 3, . . . , and a plurality of watcher terminal apparatuses 4,4, . . . to configure a so-called presence system. RFID tags 7, 7, . . . in which pieces of identification information (presentity IDs) of objects are stored are attached to objects 6, 6, . . . serving as articles. Sensors 5, 5, . . . are connected to the presence terminal apparatuses 3, 3, . . . of the presence terminal apparatuses 2, 2, . . . and 3, 3, . . . , respectively. The sensors 5, 5, . . . detect the presences of the RFID tags 7, 7, . . . within a predetermined range, respectively.

The RFID tags 7, 7, . . . may be communication devices the presences of which can be detected by the other sensors 5, 5. For example, bar-codes may be used in place of the RFID tags 7, 7, . . . , and the sensors 5, 5, . . . may be bar-code readers.

The information communication system according to the embodiment is applied to a logistics management service to monitor situations of articles in companies when articles are checked by company A, shipped to company B, and collected by company B, and delivered to company C. The presence terminal apparatuses 2, 2, . . . and 3, 3, . . . which transmit pieces of presence information of the objects 6, 6, . . . serving as articles are installed in company A and company B. The presence terminal apparatuses 2, 2, . . . of the presence terminal apparatuses 2, 2, . . . and 3, 3, . . . are used by an administrator who administrates operations of updating pieces of state information of the objects 6, 6, . . . in companies A and B and permission/rejection of the notification of presence information of the objects 6, 6, . . . . The other presence terminal apparatuses 3, 3, . . . are connected to the sensors 5, 5, . . . installed in the companies, and receive pieces of information from the sensors 5, 5, . . . which detect the presences of the RFID tags 7, 7, . . . attached to the objects 6, 6, . . . serving as articles to detect position information so that the position information can be detected. The watcher terminal apparatuses 4, 4, . . . which receive pieces of presence information of articles to display the presence information are present in company A, or company B, company C or outside the companies and are used by a user (watcher) belonging to the companies. The presence server apparatus 1 is installed outside the companies.

In the configuration according to the embodiment, in the presence terminal apparatuses 2, 2, . . . used by the administrators in companies A and B, pieces of presence information are received and displayed. Therefore, the presence terminal apparatuses 2, 2, . . . also operate as the watcher terminal apparatuses 4, 4, . . . .

In a case where positions in which the objects 6, 6, . . . are present change and is detected by the sensors 5, 5, . . . , a case where pieces of state information of the objects 6, 6, . . . are updated by the administrator, or the like, issue of pieces of presence information are detected by the presence terminal apparatuses 2, 2, . . . and 3, 3, . . . , and the pieces of presence information are notified to the watcher terminal apparatuses 4, 4, . . . through the presence server apparatus 1. In this manner, a logistics management service in which users of companies using the watcher terminal apparatuses 4, 4, . . . can monitor situations of the objects 6, 6, . . . serving as particles in real time is realized.

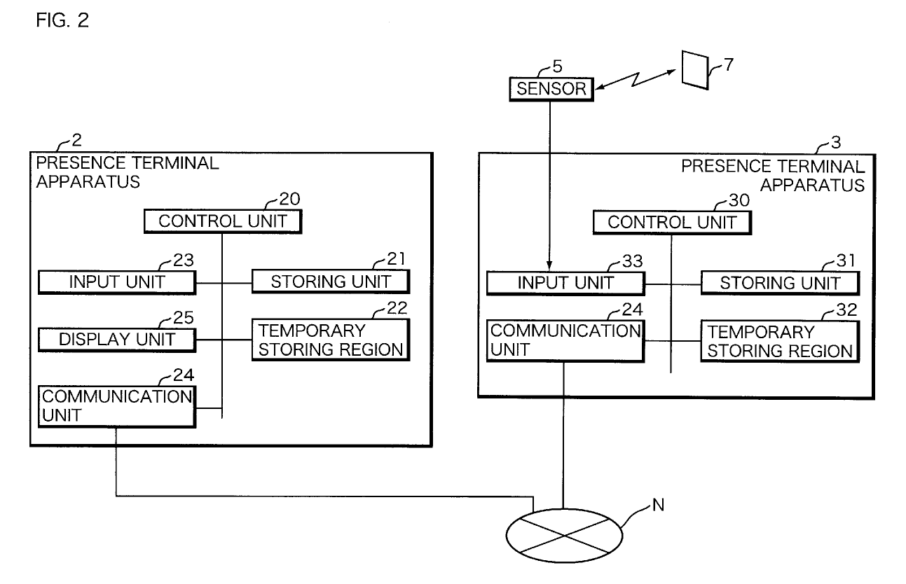

FIG. 2 is a block diagram illustrating internal configurations of the presence terminal apparatuses 2 and 3 which constitute the presence system according to the embodiment. The presence terminal apparatus 2 is constituted by a PC (Personal Computer), and includes a control unit 20 such as a CPU which controls constituent units, a storing unit 21 such as a hard disk, a temporary storing region 22 such as a DRAM (Dynamic Random Access Memory) in which various pieces of information generated by a process of the control unit 20 are temporarily stored, an input unit 23 such as a keyboard or a mouse which accepts an input operation, a communication unit 24 such as a network card which realizes connection to a network, and a display unit 25 serving as a monitor which displays various pieces of information.

The control unit 20 of the presence terminal apparatus 2 reads a control program stored in the storing unit 21 in the temporary storing region 22 and executes the control program such that the PC operates as the presence terminal apparatus 2.

The control unit 20 of the presence terminal apparatus 2 accepts an input operation of pieces of state information of the objects 6, 6, . . . by an administrator through the input unit 23. The control unit 20, when input of the pieces of state information of the objects 6, 6, . . . is accepted by the input unit 23, transmits the input pieces of state information to the presence server apparatus 1 as pieces of presence information by the communication unit 24 through a network.

The presence terminal apparatus 3, similar to the presence terminal apparatus 2, includes a control unit 30, a storing unit 31, a temporary storing region 32, an input unit 33, and a communication unit 34. The presence terminal apparatus 3 does not include a display unit, while the input unit 33 included in the presence terminal apparatus 3 has a function of receiving a signal from the connected sensor 5 and the notification the signal to the control unit 30.

When the control unit 30 of the presence terminal apparatus 3 receives the signal from the sensor 5 through the input unit 33, position information indicated by the received signal or state information derived from the position information is transmitted by the communication unit 34 to the presence server apparatus 1 as presence information through the network.

The sensors 5, 5, . . . serving as RFID readers, when the objects 6, 6, . . . are present within a predetermined range, detect the RFID tags 7, 7, . . . attached to the objects 6, 6, . . . . The sensors 5, 5, . . . receive presentity IDs of the objects 6, 6, . . . from the RFID tags 7, 7, . . . and transmit the presentity IDs to the presence terminal apparatus 3, 3, . . . together with publisher IDs serving as pieces of identification information of the sensors 5, 5.

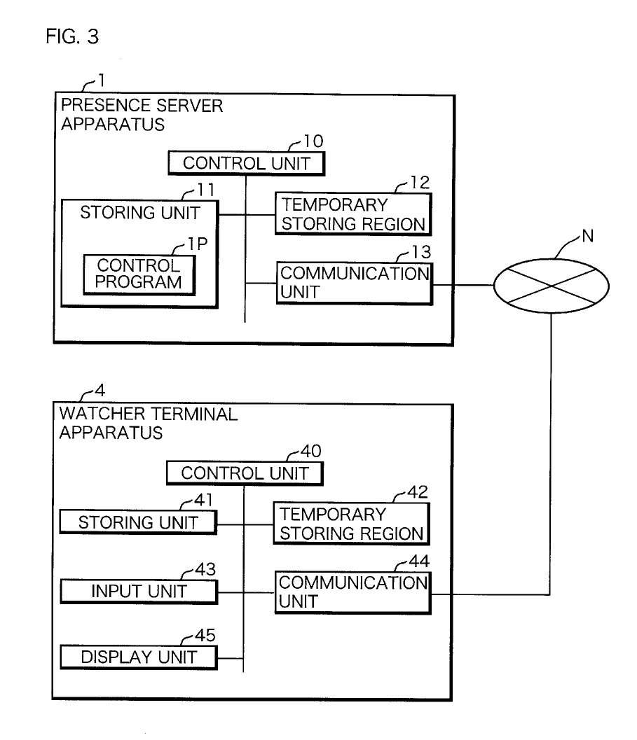

FIG. 3 is a block diagram illustrating internal configurations of the presence server apparatus 1 and a watcher terminal apparatus 4 which constitute the information communication system according to the embodiment. The presence server apparatus 1 is constituted by a server computer, and includes a control unit 10 such as a CPU and MPU which controls constituent units, a storing unit 11 such as a hard disk, a temporary storing region 12 such as a DRAM in which various pieces of information generated by a process of the control unit 10 are temporarily stored, and a communication unit 13 such as a network card which realizes a transmission/reception of data through a network.

In the storing unit 11 of the presence server apparatus 1, a control program 1P to cause a server computer to operate as the information communication system according to the present invention, i.e., the presence server apparatus 1 is stored. The control unit 10 reads and executes the control program from the storing unit 11 into the temporary storing region 12, so that the control unit 10 operates as the presence server apparatus 1.

The control unit 10 of the presence server apparatus 1 receives a subscribe request of pieces of presence information from the watcher terminal apparatuses 4, 4, . . . (will be described later) by the communication unit 13 and receives pieces of presence information updated from the presence terminal apparatuses 2, 2, . . . and 3, 3, . . . by the communication unit 13. The control unit 10 of the presence server apparatus 1 notifies of presence information to the watcher terminal apparatuses 4,4 . . . depending on the subscribe requests received from the watcher terminal apparatuses 4, 4, . . . . However, at this time, the pieces of presence information are notified after it is determined whether or not the subscription is permitted to determine whether or not the pieces of presence information can be notified to the watcher terminal apparatuses 4, 4, . . . . A process by the server apparatus 1 for determining whether or not the notification to the watcher terminal apparatuses 4, 4, . . . is permitted will be described later.

In the storing unit 11 of the presence server apparatus 1, various pieces of information to determine whether or not the notification of the presence information to the watcher terminal apparatuses 4, 4, . . . is permitted are stored. Various pieces of information stored in the storing unit 11 of the presence server apparatus 1 will be described later.

The watcher terminal apparatus 4 is constituted by a PC, a PDA (Personal Digital Assistant), a mobile phone, or the like, and includes a control unit 40 such as a CPU which controls constituent units, a storing unit 41 such as a hard disk, a temporary storing region 22 such as a DRAM in which various pieces of information generated by a process of the control unit 40 are temporarily stored, an input unit 43 such as a keyboard or a mouse which accepts an input operation, a communication unit 44 such as a network card which realizes transmission/reception of data through a network, and a display unit 45 serving as a monitor which displays various pieces of information.

In the storing unit 41 of the watcher terminal apparatus 4, a control program to cause the PC to operate as the watcher terminal apparatus 4 is stored. The control unit 40 reads and executes the control program stored in the storing unit 41 into the temporary storing region 42, so that a user (watcher) of the watcher terminal apparatus 4 displays a screen to input information about the subscribe request of the presence information on the display unit 45. Furthermore, the control unit 40 accepts the information input by the user through the input unit 43 to create the subscribe request of the presence information, and the subscribe request is transmitted to the presence server apparatus 1 by the communication unit 44.

When the control unit 40 of the watcher terminal apparatus 4 receives the presence information, which is permitted to be notified by the presence server apparatus 1 and notified, from the communication unit 44, the control unit 40 displays the received presence information on the display unit 45.

In the information communication system according to the present invention configured as described above, a process of causing the presence server apparatus 1 to determine whether or not pieces of presence information updated from the presence terminal apparatuses 2, 2, . . . and 3, 3, . . . to the watcher terminal apparatuses 4, 4, . . . depending on the subscribe requests transmitted from the watcher terminal apparatuses 4, 4, . . . will be described below.

A process of transmitting pieces of presence information of the objects 6, 6, . . . displayed on the display unit 45 of the watcher terminal apparatus 4 and a subscribe request of presence information from the watcher terminal apparatus 4 will be described below.

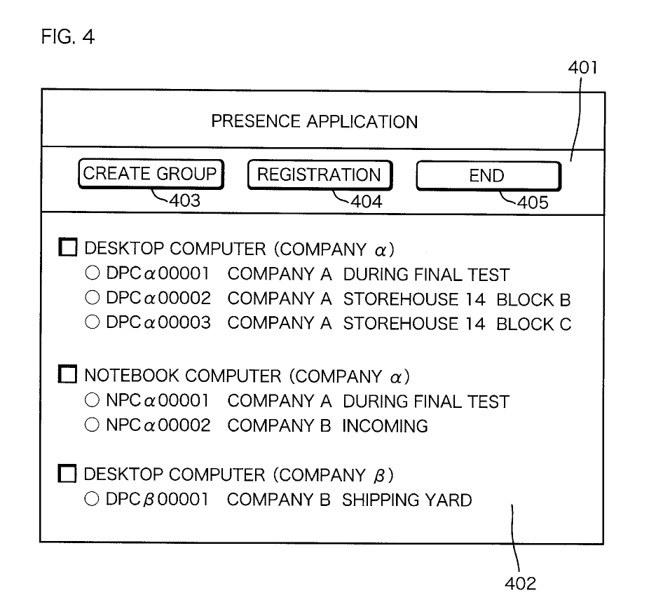

FIG. 4 is an example diagram illustrating a screen displayed on the display unit 45 of the watcher terminal apparatus 4 according to the embodiment. The screen shown in the example diagram shown in FIG. 4 is displayed when the control unit 40 reads and executes the control program stored in the storing unit 41 of the watcher terminal apparatus 4. In the screen shown in the example diagram in FIG. 4, when the control unit 40 displays an input screen of a watcher ID on the display unit 45, the watcher ID is input by a user. The screen is displayed on the display unit 45 when the input watcher ID is transmitted to the presence server apparatus 1 and then authenticated. At this time, the control unit 40 stores an authenticated watcher ID in the temporary storing region 42 and holds the watcher ID until the process of displaying presence information is ended.

The screen shown in the example diagram shown in FIG. 4, as described above, is configured to be displayed on the display unit 45 by causing the control unit 40 to read the control program stored in the storing unit 41 of the watcher terminal apparatus 4. However, the screen is not limited to this configuration. When a user logs in a logistics monitoring system with the watcher ID in the watcher terminal apparatus 4, a screen transmitted to the watcher terminal apparatus 4 by the operation of the presence server apparatus 1 and displayed on the display unit 45 may be used.

The screen shown in the example diagram in FIG. 4 includes a tool bar 401 and a presence information display area 402. In the presence information display area 402, a list of latest information of presence information permitted to be notified with respect to the login watcher ID is updated in real time and displayed. In the screen in FIG. 4, process information “during the final test in company A” and pieces of position information “company A 14 storehouse block B” and “company A 14 storehouse block C” about the objects 6, 6, . . . (article is Desktop PC available from company α) having “DPCα00001” to “DPCα00003” as presentity names (IDs) are displayed as pieces of presence information. Similarly, pieces of process information “during the final test in company A” and “stocked in company B” about the objects 6, 6, . . . (article is Note PC available from company α) having “NPCα00001” and “NPCα00002” as presentity names are displayed as pieces of presence information. Similarly, pieces of position information “shipment yard in B company” about the objects 6, 6, . . . (article is Desktop PC available from company 8) having “DPCβ00001” as presentity names are displayed as pieces of presence information. Presence information displayed in bold letters is presence information updated within a predetermined period of time lately.

The objects 6, 6, . . . are grouped and displayed. The objects 6, 6, . . . having presentity names “DPCα00001” to “DPCα00003” are classified into a group “company α desktop personal computer”, the objects 6, 6, . . . having presentity names “DPCα00001” and “DPCα00002” are classified into a group “company α notebook personal computer”, and the objects 6, 6, . . . having a presentity name “DPCβ00001” are classified into a group “company 8 desktop personal computer”.

In the tool bar 401, a button which accepts an input operation by a user is displayed. In the screen shown in the example diagram in FIG. 4, a “group creating” button 403, a “registration” button 404, and an “end” button 405 are displayed.

The “group creating” button 403 in the screen in FIG. 4 is a button to register a group such that pieces of presence information are arranged and displayed. A user operates a mouse or the like of the input unit 43 and depresses the “group creating” button 403 to create a group. The user can display pieces of presence information to be displayed in association with the groups.

The “registration” button 404 in the screen in FIG. 4 is a button used when a user who is a watcher requests the presence server apparatus 1 to subscribe the pieces of presence information of the objects 6, 6, . . . . The user operates the mouse or the like of the input unit 43 and depresses the “registration” button 404, so that an input operation for information can be performed to request pieces of presence information of the desired objects 6, 6, . . . to be subscribed.

The “end” button 405 in the screen in FIG. 4 is a button to close a connection to the presence server apparatus 1 and to designate the control unit 40 to end a process of displaying the presence information.

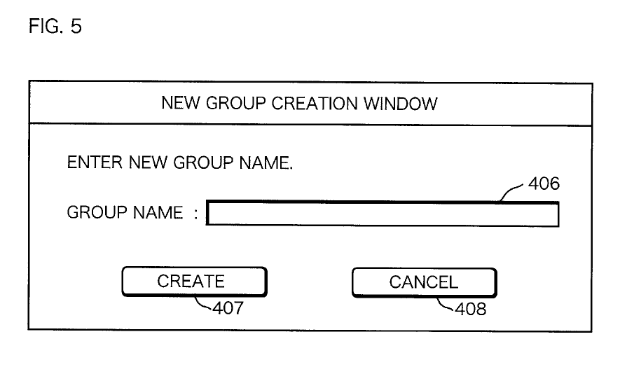

FIG. 5 is an example diagram illustrating a screen displayed in formation of a group on the display unit 45 of the watcher terminal apparatus 4 according to the embodiment. The screen shown in the example diagram in FIG. 5 is an example displayed when the control unit 40 detects that the “group creating” button 403 in the screen in FIG. 4 is depressed by the input unit 43.

In the screen in FIG. 5, an edit box 406 in which a group name is input, a “creating” button 407 to designate the control unit 40 to execute creation of a group, and a “cancel” button 408 to designate the control unit 40 to stop a process of “group creation” are displayed. A user who is a watcher inputs a character string of an arbitrary group name in the edit box 406 and depresses the “creating” button 407 by the input unit 43. The control unit 40 of the watcher terminal apparatus 4 detects an input by the user from the input unit 43 and stores a group name constituted by the input character string in the storing unit 41 or the temporary storing region 42. In this manner, the group is created.

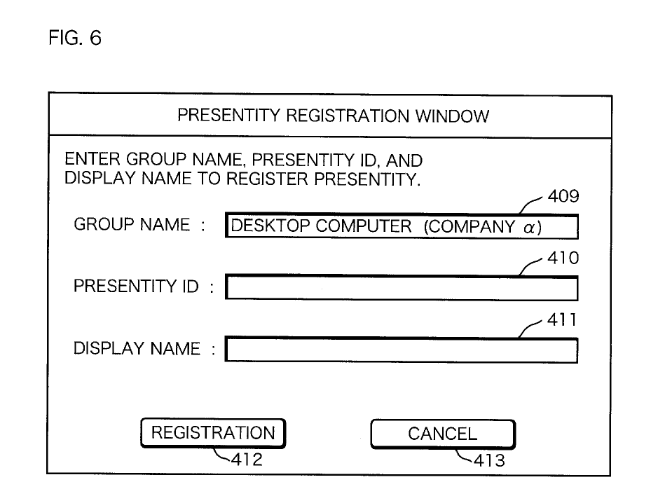

FIG. 6 is an example diagram illustrating a screen displayed in a presence information creating request on the display unit 45 of the watcher terminal apparatus 4 according to the embodiment. The screen shown in the example diagram in FIG. 6 is an example displayed when the control unit 40 detects that the “registration” button 404 in the screen in FIG. 4 is depressed by the input unit 43.

In the screen in FIG. 6, a drop-down menu 409 (selection box) to select a group name, an edit box 410 in which presentity IDs of the objects 6, 6, . . . requesting the presence information to be subscribed are input, an edit box 411 in which a presentity name used when presence information is displayed in a presence area is input, a “registration” button 412 to designate the control unit 40 to transmit a subscribe request of the presence information, and a “cancel” button 413 to designate the control unit 40 to stop a process for “registration” are displayed. The user can select a group with which presence information requested to be subscribe is associated from the drop-down menu 409. The user inputs the presentity IDs of the objects 6, 6, . . . requesting the edit box 411 to subscribe of the presence information, inputs a presentity name used when the presence information is displayed in the edit box 411, and depresses the “registration” button 412 so that the subscribe requests of the pieces of presence information about the objects 6, 6, . . . of the input presentity ID can be transmitted to the control unit 40. The control unit 40 of the watcher terminal apparatus detect depression of the “registration” button 412 by the user from the input unit 43 from the input unit 43, acquires character strings of the selected group, the input presentity ID, and the presentity name, and executes a creating process and a transmitting process for a subscribe request transmitted to the presence server apparatus 1.

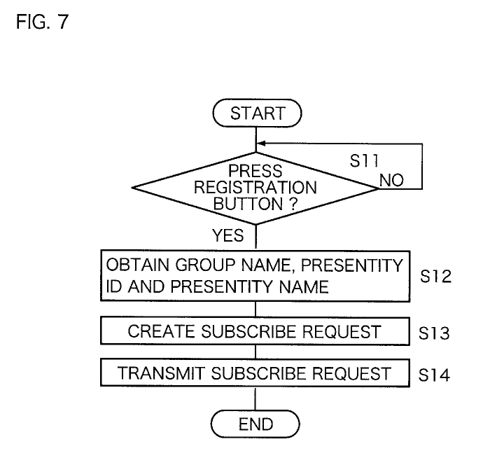

FIG. 7 is a flow chart illustrating procedures of the creating process and the transmitting process for a subscribe request by the control unit 40 of the watcher terminal apparatus 4 according to the embodiment.

The control unit 40 of the watcher terminal apparatus 4 determines whether or not depression of the “registration” button 412 shown in the example diagram in FIG. 6 is detected by the input unit 43 (step S11). When the control unit 40 determines that the depression of the “registration” button 412 is not detected (S11: NO), the control unit 40 returns the process to step S11 and waits until it is determined that the depression of the “registration” button 412 is detected.

When the control unit 40 determines that the depression of the “registration” button 412 is detected (S11: YES), the control unit 40 acquires the selected group name, the input presentity ID, and the presentity name (step S12). The control unit 40 creates a subscribe request for the presence information including a subscribe request command, the watcher ID stored in the temporary storing region 42, the presentity ID and the presentity name acquired in step S12 (step S13), transmits the created the subscribe request to the presence server apparatus 1 (step S14), and ends the process. A watcher ID included when the subscribe request is created in step S13, as described in the explanation in FIG. 4, is input to an input screen of the watcher ID displayed on the display unit 45 by the user, authenticated by the presence server apparatus 1, and stored in the temporary storing region 42.

The control unit 40 of the watcher terminal apparatus 4, after the process in step S14, keeps connection to the presence server apparatus 1 until it is detected that the “end” button 405 in the screen in FIG. 4 is depressed by the input unit 43. The control unit 40 receives the notification of presence information permitted to be subscribed from the presence server apparatus 1 and continues a process of displaying the received presence information in the presence information display area 402 shown in the screen in FIG. 4 in association with a group acquired in step S12.

With respect to a subscribe request transmitted from the watcher terminal apparatus 4 as described above, a process of causing the presence server apparatus 1 to determined whether or not the subscription is permitted will be described below. Various pieces of information to determine whether or not the subscription is permitted, the pieces of information being stored in the storing unit 11 of the presence server apparatus 1, will be described below.

In the storing unit 11 of the presence server apparatus 1, presentity IDs which identify presentities are stored. As pieces of information which express attributes of the presentities, for example, company names of products and general names of articles are stored in associated with each other. In the storing unit 11 of the presence server apparatus 1, watcher IDs are stored. The watcher IDs store attributes of a user who is a watcher, for example, any one of company A, company B, and company C to which the user belongs, in association with each other. Information to specify the presence terminal apparatuses 2, 2, . . . and 3, 3, . . . , IDs of administrators of companies using the presence terminal apparatuses 2, 2, . . . and 3, 3, . . . , and IDs of the sensors 5, 5, . . . are stored. The control unit 10 of the presence server apparatus 1 can read the IDs.

In the storing unit 11 of the presence server apparatus 1, as various pieces of information to determine whether or not the notification to the watcher terminal apparatuses 4, 4, . . . is permitted, policy information including watcher IDs, contents of the pieces of presence information, and conditions which permit the subscription based on attributes of publishers (administrators or the sensors 5, 5, . . . ) which issue the presence information are stored. In the storing unit 11, an exception list which is a list of the subscribe requests which are matched with the conditions of the policy information but do not apply a policy is stored.

Furthermore, as various pieces of information to determine whether or not the subscription is permitted, a list (buddy list) in which the subscribe requests transmitted from the watcher terminal apparatuses 4, 4, . . . are stored and a watcher list representing correspondence between the latest contents of pieces of presence information of presentity IDs and watcher IDs permitted to notify of the pieces of presence information are stored. In the storing unit 11 of the presence server apparatus 1, a content processing rule to process contents notified by a user when the pieces of presence information are notified to the watcher terminal apparatuses 4, 4.

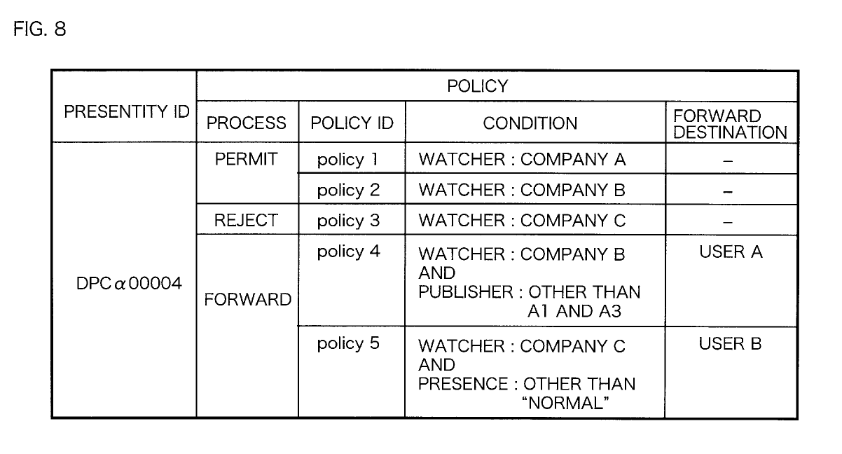

FIG. 8 is an example diagram illustrating a content of policy information stored in the storing unit 11 of the presence server apparatus 1 according to the embodiment.

As shown in the example diagram in FIG. 8, the policy information stores, for every presentity ID, a policy in which a process related to presence information to notify of presence information of the objects 6, 6, . . . of the presentity ID to the watcher terminal apparatuses 4, 4, . . . . The policy includes, as a process performed when the policy is applied, any one of the subscription permission, the subscription rejection, and the subscription forward. The policy includes identification information (ID) which identifies the content of the policy and includes a conditional expression to which the policy is applied. The policy includes an administrator ID of a predetermined administrator of a forward destination in the case where a process performed when the policy is applied is the “subscription forward” or an ID of a predetermined terminal apparatus used by an administrator.

In the content shown in the example diagram in FIG. 8, a policy about an object 6 having “DPCα00004” as a presentity ID is expressed. In the content in FIG. 8, presence information of the object 6 having “DPCα00004” as the presentity ID is stored as the policy information of ID “policy1”, the presence information being unconditionally notified to the watcher terminal apparatus 4 used by a user belonging to company A. To the watcher terminal apparatus 4 used by a user belonging to company B, except when the presence information is information registered in the presence terminal apparatus 2 by an administrator of company A and is position information issued by a signal transmitted from a predetermined sensor 5 of the sensors 5, 5, . . . belonging to company A, a fact that a “subscription forward” process (the subscription permission/rejection inquiry process) is performed to the presence terminal apparatus 2 used by the administrator (ID “UserA”) of company A is stored as pieces of presence information of a policy ID “policy4”. In the presence information of the object 6 having “DPCα00004” as the presentity ID, to the watcher terminal apparatus 4 belonging to company C, a fact that a “subscription forward” process is performed to the presence terminal apparatus 2 used by an administrator (ID “UserB”) of company B except when the content of the presence information is information representing “normal” is stored as policy information of policy ID “policy5”.

When the control unit 10 of the presence server apparatus 1 receives the subscribe requests from the watcher terminal apparatuses 4, 4, . . . , the control unit 10 specifies an organization (company A, company B, or the like) to which a user belongs by using a watcher ID received together with the subscribe request as a key to make it possible to determine a specific policy to be applied. Depending on the content of the presence information serving as a destination of the subscribe request or an ID of a publisher which issues the presence information, a policy to be applied can be determined.

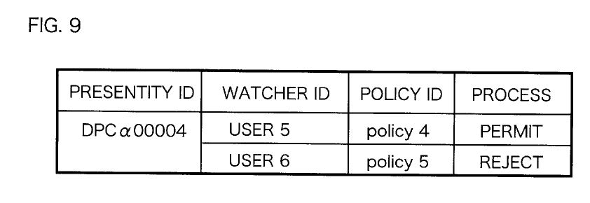

FIG. 9 is an example diagram illustrating a content of an exception list stored in the storing unit 11 of the presence server apparatus 1 according to the embodiment.

As shown in the example diagram in FIG. 9, the exception list is a list in which the subscribe requests to which a policy is not applied when presence information is notified are stored for every presentity ID of the objects 6, 6, . . . . As the subscribe requests, both “rejection”/“permission” flags representing that the subscription is permitted/rejected without applying the policy are stored.

More specifically as shown in the example diagram in FIG. 8, policy information representing whether or not the presence information of the object 6 having a presentity ID “DPCα00004” is notified is present. With respect to the subscribe request having a watcher ID “User5” as a notification destination, since a user identified by the watcher ID “User5” belongs to company B, a policy having a policy ID “policy4” may be applied. In contrast to this, in the exception list shown in the example diagram in FIG. 9, a fact that the policy having the policy ID “policy4” is not applied to a subscribe request from the watcher ID “User5” requesting the subscription of the presence information of the object 6 having the presentity ID “DPCα00004”, but the subscription is permitted is stored. Similarly, a fact that the notification of a subscribe request to the presence information of the object 6 having a watcher ID “User6” as a notification destination and the presentity ID “DPCα00004” is rejected without applying the policy ID “policy5” is stored. More specifically when a pending cause of the subscribe request from the watcher ID “User6” to the subscription of the presence information of the object 6 having the presentity ID “DPCα00004” is only the policy having the policy ID “policy5”, the policy is not applied. A process to the subscribe request stored in the exception list is performed in preference to other determination whether or not the notification is permitted.

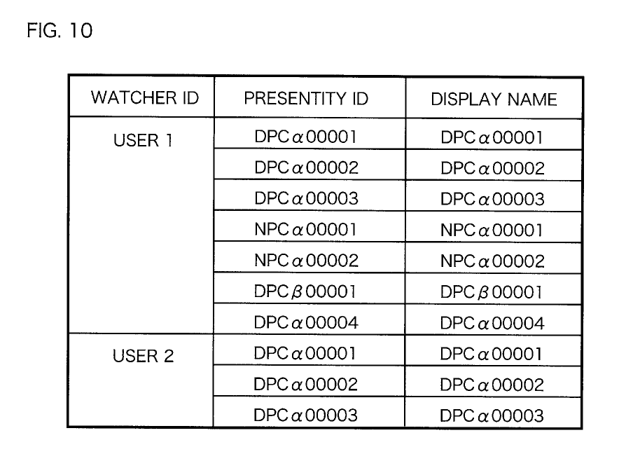

FIG. 10 is an example diagram illustrating a content of a buddy list stored in the storing unit 11 of the presence server apparatus 1a according to the embodiment. The buddy list is a list of the subscribe requests to pieces of presence information of the objects 6, 6, . . . transmitted from the watcher terminal apparatuses 4, 4, . . . . In this case, in association with watcher IDs corresponding to the watcher terminal apparatuses 4, 4, . . . , a list of presentity IDs of the objects 6, 6, . . . (presentities) is stored as a transmitted the subscribe request.

The content shown in the example diagram in FIG. 10 shows that, from the watcher terminal apparatus 4 used by a user having a watcher ID “User1”, the subscription of the pieces of presence information of the objects 6, 6, . . . having the presentity IDs “DPCα00001” to “DPCα00004”, “DPCα00001”, “DPCα00002”, and “DPCβ00001” are requested. Similarly, the content expresses that, from the watcher terminal apparatus 4 used by a user having a watcher ID “User2”, the subscription of pieces of presence information of the objects 6, 6, . . . having the presentity IDs “DPCα00001” to “DPCα00003” is requested. Furthermore, in the content shown in the example diagram in FIG. 10, all the presentity names of the objects 6, 6, . . . are stored.

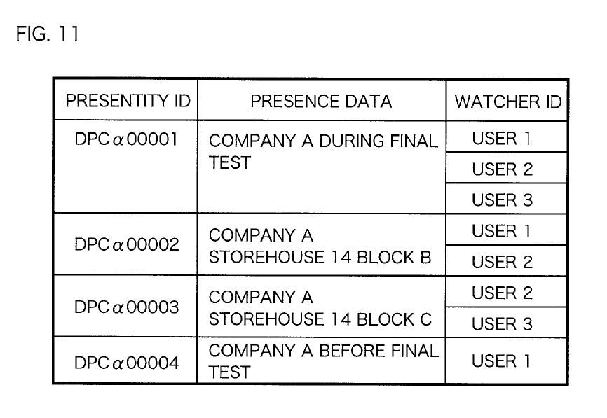

FIG. 11 is an example diagram illustrating a content of a watcher list stored in the storing unit 11 of the presence server apparatus 1 according to the embodiment. As shown in the example diagram in FIG. 11, a watcher list is a list in which watcher IDs of users permitted to the subscription of presence information are described for every presentity ID of the objects 6, 6, . . . . In this case, in association with the presentity IDs of the objects 6, 6, . . . , pieces of real-time presence information of the objects 6, 6, . . . and watcher IDs of the users permitted to notify of the presence information are described in the list.

The content shown in the example diagram in FIG. 11 shows that the latest presence information of the object 6 having the presentity ID “DPCα00001” is “during the final test in company A” and that the watcher terminal apparatuses 4, 4 used by the users having watcher IDs “User1”, “User2”, and “User3” are permitted to notify of the presence information of the object 6. Similarly, the latest presence information of the object 6 having the presentity ID “DPCα00002” is “company A 14 storehouse block B”, and the latest presence information of the object 6 having the presentity ID “DPCα00003” is “company A 14 storehouse block C”, and the latest presence information of the object 6 having the presentity ID “DPCα00004” is “before the start of the final test in company A”.

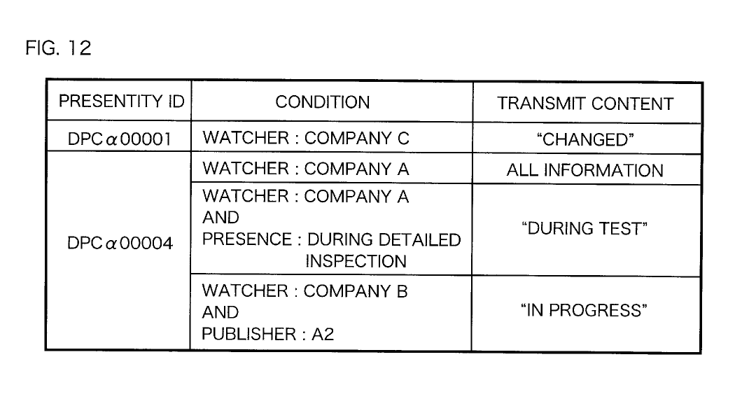

FIG. 12 is an example diagram illustrating a content of a content processing rule stored in the storing unit 11 of the presence server apparatus 1 according to the embodiment. As shown in FIG. 12, as the content processing rule, in association with the presentity IDs of the objects 6, 6, . . . , conditions for processing a content of presence information and a content of presence information transmitted as a result of the processing are stored. More specifically, the content processing rule is a rule in which, for each of the objects 6, 6, . . . , a content disclosed depending on one or two or more of the content of the presence information, attribute information of an object, attribute information of a user who is a watcher, and attribute information of a publisher which issues the presence information is described.

In the content shown in the example diagram in FIG. 12, the rule is described such that the content is always notified by processing the content to “changed” when the presence information of the object 6 having the presentity ID “DPCα00001” is notified to the watcher terminal apparatuses 4, 4, . . . used by a user belonging to company C. Similarly, with respect to the presence information of the object 6 having the presentity ID “DPCα00004”, all the pieces of information are directly notified without processing the content to the watcher terminal apparatuses 4, 4, . . . used by a user belonging to company A. However, as an exception, when the content of the presence information is “in detailed inspection”, the rule is described such that the content is simply processed as “in test”. Furthermore, the rule is described such that the content is processed as “in progress” and notified when the presence information of the object 6 having the presentity ID “DPCα00004” is notified to the watcher terminal apparatuses 4, 4, . . . used by the user belonging to company B and when an ID of a publisher which issues the latest presence information of the object 6 is “A2”.

The control unit 10 of the presence server apparatus 1 is configured such that, according to the content processing rule shown in the example diagram in FIG. 12, a content of presence information to be notified is changed depending on a content of presence information, an attribute of the object 6, an attribute of a user who is a watcher, and an attribute of a publisher.

As described above, a process of determining whether or not the subscription is permitted with respect to the subscribe requests transmitted from the watcher terminal apparatuses 4, 4, . . . based on the various pieces of information stored in the storing unit 11 will be described below.

When the presence server apparatus 1 receives a subscribe request transmitted from the watcher terminal apparatuses 4, 4, . . . and including a subscribe request command, a watcher ID, a presentity ID, and a presentity name, the presence server apparatus 1 stores the subscribe request in the buddy list and determines, with reference to the policy information, whether or not the subscribe request is matched with a condition to which the policy is applied to determine whether or not the subscription is possible to accept. The control unit 10 of the presence server apparatus 1, when the subscription about the received the subscribe request is permitted, notifies of presence information which is latest at this time. When the subscription is permitted in the determination whether or not the subscription is permitted based on the policy information, the control unit 10 stores the subscribe request in the watcher list. In this manner, when presence information is issued and notified later, the control unit 10 can notify of the presence information to the watcher terminal apparatuses 4, 4, . . . which are permitted with reference to the watcher list.

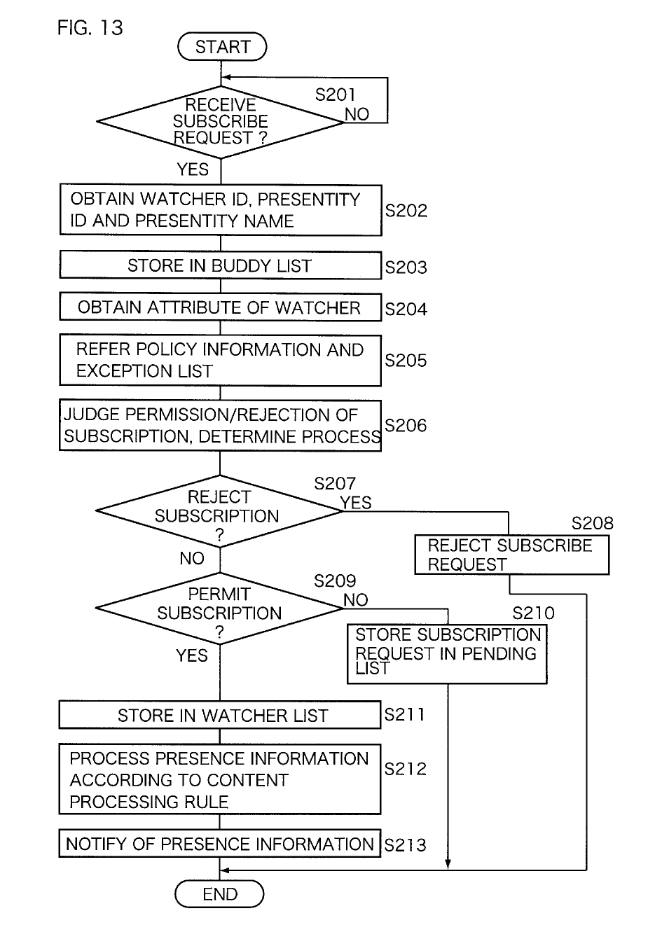

FIG. 13 is a flow chart illustrating a procedure in which the control unit 10 of the presence server apparatus 1 according to the embodiment determines whether or not the subscription is permitted with respect to a received the subscribe request.

The control unit 10 of the presence server apparatus 1 determines whether or not a subscribe request is received from the watcher terminal apparatuses 4, 4, . . . (step S201). When the control unit 10 determines that the subscribe request is not received (S201: NO), the control unit 10 returns the process to step S201 and waits until it is determined that the subscribe request is received.

When the presence server apparatus 1 determines that the subscribe request is received (S201: YES), the control unit 10 acquires a watcher ID, a presentity ID, and a presentity name included in the received the subscribe request (step S202). The control unit 10 stores the watcher ID, the presentity ID, and the presentity name acquired in step S202 as a subscribe request in the buddy list (step S203), and acquires an attribute of a user (watcher) stored in the storing unit 11 for every watcher ID (step S204).

The control unit 10 refers to the exception list and the policy information stored in the storing unit 11 (step S205), compares the attribute of the user acquired in step S204 and the conditions of the policy to determine whether or not the subscription about the subscribe request received in step S201 is permitted. Furthermore, when the subscribe request is stored in the exception list with reference to the exception list, even though the subscribe request is matched with the conditions of the policy a process set in the exception list is read to determine the process (step S206).

The control unit 10 determines whether or not the process determined in step S206 is rejection of the subscription (step S207). When the control unit 10 determines that the determined process is rejection of the subscription (S207: YES), the subscribe request is rejected (step S208), and the process is ended.

On the other hand, when the control unit 10 determines that the determined process is not rejection of the subscription (S207: NO), it is determined whether or not the process determined in step S206 is rejection of the subscription (step S209).

When the control unit 10 determines whether or not the determined process is not rejection of the subscription (S209: NO), the notification request is stored in a pending list (step S210), and the process is ended.

When the control unit 10 determines that the determined process is rejection of the subscription (S209: YES), the control unit 10 stores the subscribe request in the watcher list (step S211). According to the content processing rule stored in the storing unit 11, the content of the latest presence information is processed as needed (step S212). The control unit 10 notifies of the presence information the content of which is processed to the permitted watcher terminal apparatuses 4, 4, . . . (step S213), and the process is ended.

As shown in the procedure of the flow chart in FIG. 13, a fact that the subscribe request is conditionally permitted is stored in the policy information. At this time, when a process cannot be determined, the subscribe request is stored in the pending list. In the content of the policy information in FIG. 8, the subscribe request stored in the pending list is a subscribe request requesting an inquiry process at an administrator. In addition, also when conditions are set with respect to the content of the presence information, the attribute of the publisher, or the like, the subscribe request is stored in the pending list.

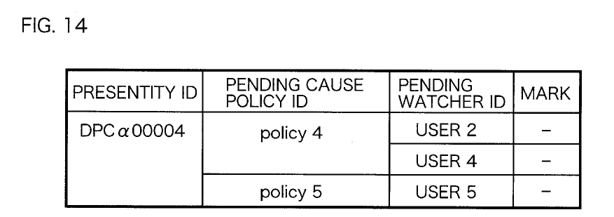

FIG. 14 is an example diagram illustrating a content of the pending list stored in the storing unit 11 by the control unit 10 of the presence server apparatus 1 according to the embodiment. FIG. 14 shows a result stored in step S210 in the procedure of the control unit 10 shown in the flow chart in FIG. 13.

As shown in the example diagram in FIG. 14, in the pending list, for every presentity ID of the objects 6, 6, . . . serving as a destination of a subscribe request, the watcher ID of the subscribe request, an ID of a policy which causes pending, and a mark representing whether or not the policy is applied are stored.

The content in the example diagram in FIG. 14 shows that a subscribe request requesting the subscription of presence information of the object 6 having the presentity ID “DPCα00004” from users having the watcher IDs “User2” and “User4” is pending because the conditions may be matched with the policy “policy4”. Similarly, the content expresses that the subscribe request requesting the subscription of the presence information of the object 6 having the presentity ID “DPCα00004” from the user having the watcher ID “User5” is pending because the conditions may be matched with the policy “policy5”.

The mark representing whether or not the policy is applied represents that, when the mark is set, even though the subscribe request is stored in the pending list, a pending cause policy is not applied. The mark represents “permission”/“rejection”. When the mark represents “permission”, the subscription is rejected without evaluating and applying the pending cause policy. When the mark represents “rejection”, the subscription is permitted without evaluating and applying the pending cause policy. The mark representing whether or not the policy is applied is not set in the example diagram in FIG. 14. The mark is set in the process which will be explained later.

In the present invention, when presence information related to the subscribe request stored in the pending list is issued and notified, the control unit 10 of the presence server apparatus 1 verifies a pending cause stored in the pending list and executes a process of asking an administrator, as needed, whether or not a subscribe request about the presence information is notified.

One concrete example about the above processes will be explained such that a case where a user of the watcher ID “User1” logs in the watcher terminal apparatus 4 to perform an operation of requesting the subscription of presence information of the object 6 having the presentity ID “DPCα00004” which is a desktop personal computer available from company α is applied to the processes.

First, a user having “User1” logs in the watcher terminal apparatus 4, and the user depresses the “registration” button 404 in the screen shown in FIG. 4 to display the screen shown in FIG. 6. The user “user1” selects a group “desktop personal computer available from company α” from the drop-down menu 409, inputs the presentity ID and the presentity ID “DPCα00004” in the edit boxes 410 and 411, respectively and depresses the “registration” button 412. In this manner, the control unit 40 of the watcher terminal apparatus 4 executes the procedure shown in the flow chart in FIG. 7, and the subscribe request command, the watcher ID “User1”, the presentity ID “DPCα00004”, and the presentity name “DPCα00004” are transmitted from the watcher terminal apparatus 4 to the presence server apparatus 1 as the subscribe request.

The control unit 10 of the presence server apparatus 1 receives the subscribe request to execute the procedure shown in the flow chart in FIG. 13. In this case, the control unit 10 refers to the policy information and the exception list by the process in step S205 based on the presentity ID “DPCα00004” and the watcher ID “User1”. At this time, the control unit 10 can recognizes that the user having the watcher ID “User1” belongs to company A by the process in step S204.

As shown in the example diagram in FIG. 8, with respect to the object 6 having the presentity ID “DPCα00004”, when the user belongs to company A, the policy having the policy ID “policy1” is applied, and the subscription is unconditionally permitted. Since items about the watcher ID “User1” are not stored in the exception list, the subscription is permitted.

Therefore, the control unit 10 of the presence server apparatus 1 executes the process in step S211. In this manner, as shown in the example diagrams in FIGS. 10 and 11, a fact that the watcher terminal apparatus 4 used by the watcher ID “User1” is permitted to subscribe the presence information of the object 6 having the presentity ID “DPCα00004” is stored in the watcher list.

Furthermore, the control unit 10 of the presence server apparatus 1 executes the processes in step S212 and step S213. In this manner, as shown in example diagram in FIG. 12, as the presence information of the object 6 having the presentity ID “DPCα00004”, since the content processing rule is set to subscribe all pieces of information when a user who is a watcher belongs to company A, presence information representing “before the start of the final test in company A” in the watcher list is notified to the watcher terminal apparatus 4 used by the watcher ID “User1”.

As another concrete example, described is an example to which a case where the user having the watcher ID “User2” performs an operation of requesting the subscription the presence information of the object 6 having the presentity ID “DPCα0000” is applied. In this case, the subscribe request command, the watcher ID “User2”, the presentity ID “DPCα00004”, and the presentity name “DPCα00004” are transmitted from the watcher terminal apparatus 4 to the presence server apparatus 1.

In this case, the control unit 10 of the presence server apparatus 1, similarly, refers to the policy information by the process in step S205 of the procedure shown in the flow chart in FIG. 13 based on the presentity ID “DPCα00004” and the watcher ID “User2”. At this time, the control unit 10 can recognize that the user having the watcher ID “User2” belongs to company B by the process in step S204.

As shown in the example diagram in FIG. 8, with respect to the subscribe request of the object 6 having the presentity ID “DPCα00004”, when the user belongs to company B, the policy having the policy ID “policy4” is applied. The conditions of “policy2” are also matched with the user who belongs to company B. However, since the matching conditions of the policy having the policy ID “policy4” include elements which cannot be determined at this time (conditions of a publisher), the policy having the policy ID “policy4” is also applied to temporarily pending determination. In this manner, a subscribe request from the watcher terminal apparatus 4 used by the watcher ID “User2” about the presentity ID “DPCα00004” is stored in the pending list such that the policy having the policy ID “policy4” as shown in the example diagram in FIG. 14 is used as a pending cause.

In this manner, in the storing unit 11 of the presence server apparatus 1, as a result of determination whether or not the subscription is permitted, the subscribe request is stored in the watcher list. In the pending list, the subscribe request in which the determination whether or not the subscription is permitted is pending is stored. On the other hand, presence information is issued by the publisher. When the presence information is updated from the presence terminal apparatuses 2, 2, . . . and 3, 3, . . . to the presence server apparatus 1, with reference to the watcher list and the pending list, it is determined whether or not the presence information is notified to the watcher terminal apparatuses 4, 4, . . . .

The process of the sending the presence information from the presence terminal apparatuses 2, 2, . . . and 3, 3, . . . will be described below.

The sensors 5, 5, . . . are publishers which issue pieces of presence information (position information) of the objects 6, 6, . . . by detecting the objects 6, 6, . . . . When the objects 6, 6, . . . are present in a predetermined range and the presentity IDs are transmitted from the RFID tags 7, 7, . . . attached to the objects 6, 6, . . . , the sensors 5, 5, . . . input the presentity IDs in the input units 33 of the presence terminal apparatuses 3, 3, . . . together with the publisher IDs of the sensors 5, 5.

The presence terminal apparatuses 3, 3, . . . which receive the presentity IDs and the publisher IDs from the sensors 5, 5, . . . through the input units 33 send of the presence information to the presence server apparatus 1. The control units 30 of the presence terminal apparatuses 3, 3, . . . sending presence information having a content corresponding to that the objects 6, 6, . . . identified by the presentity IDs are detected by the sensors 5, 5, . . . identified by the publisher IDs, for example, the control units 30 update presence information having a content representing “arrival at receiving gate” when the sensor 5 detects the object, since the sensor 5 is installed near a receiving gate of company A. The control units 30 of the presence terminal apparatuses 3, 3, . . . , when presence information is received, transmit presence update commands, character strings expressing contents of the presence information, the presentity IDs, and the publisher IDs.

By the input units 23 included in the presence terminal apparatuses 2, 2, . . . , an administrator may update and set the content of the presence information with respect to the objects 6, 6, . . . . The administrator updates and sets the content of the presence information to serve as a publisher who issues the presence information. The control units 20 of the presence terminal apparatuses 2, 2, . . . cause the display units 25 of the presence terminal apparatuses 2, 2, . . . to display input screens which accept an input of the publisher ID of the administrator and acquires the input publisher ID. Thereafter, the control units 20 of the presence terminal apparatuses 2, 2, . . . , in order to input the pieces of presence information of the objects 6, 6, . . . , display operation screens (not shown) each constituted by a drop-down menu to select the presentity IDs of the objects 6, 6, . . . and an edit box to input a content of the presence information, for example, “in detailed test” or the like. Each of the control units 20 of the presence terminal apparatuses 2, 2, . . . detects an input in the operation screen by the administrator to acquire a selected presentity ID and a character string of the input content of the presence information.

The control units 20 and 30 of the presence terminal apparatuses 2, 2, . . . and 3, 3, . . . transmit presence update commands, character strings expressing the contents of the pieces of presence information input by the input units 23 and 33, the presentity IDs, and the publisher IDs to the presence server apparatus 1 to send the presence information.

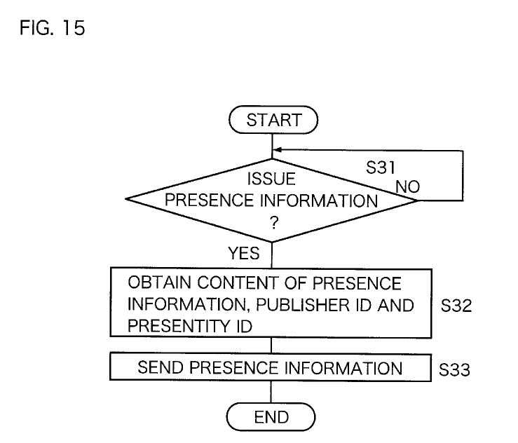

FIG. 15 is a flow chart illustrating a procedure in which the control units 20 and 30 of the presence terminal apparatuses 2 and 3 according to the embodiment detect that pieces of presence information of the objects 6, 6, . . . are issued by the input units to notify of the presence information.

The control units 20 and 30 of the presence terminal apparatus 2 and the presence terminal apparatus 3 determine whether or not an issue of the pieces of presence information of the objects 6, 6, . . . is detected by checking whether or not the publisher ID, the presentity ID, and the content of the presence information are input by the input unit 23 or whether or not the presentity ID and the publisher ID from the sensor 5 by the input unit 33 (step S31).

When the control units 20 and 30 determine that the issue of the presence information is not detected (S31: NO), the control units 20 and 30 return the process to step S31 and wait until it is determined that the issue of the presence information is detected.

When the control units 20 and 30 detect that the issue of the presence information is detected (S31: YES), the control units 20 and 30 acquire the content of transmitted or input presence information, a publisher ID, and a presentity ID (step S32), transmit the acquired pieces of information to send the pieces of presence information to the presence server apparatus 1 (step S33), and end the update process for the presence information.

As described above, when the pieces of presence information are sent from the presence terminal apparatuses 2, 2, . . . and 3, 3, . . . , the presence server apparatus 1 notifies of the pieces of presence information to the watcher terminal apparatuses 4, 4, . . . which are permitted to subscribe the notified pieces of presence information. With respect to a subscribe request stored in a pending list, the presence server apparatus 1 determines whether or not the presence information is notified depending on the content of the presence information or whether or not an inquiry process at the presence terminal apparatuses 2, 2, . . . is required.

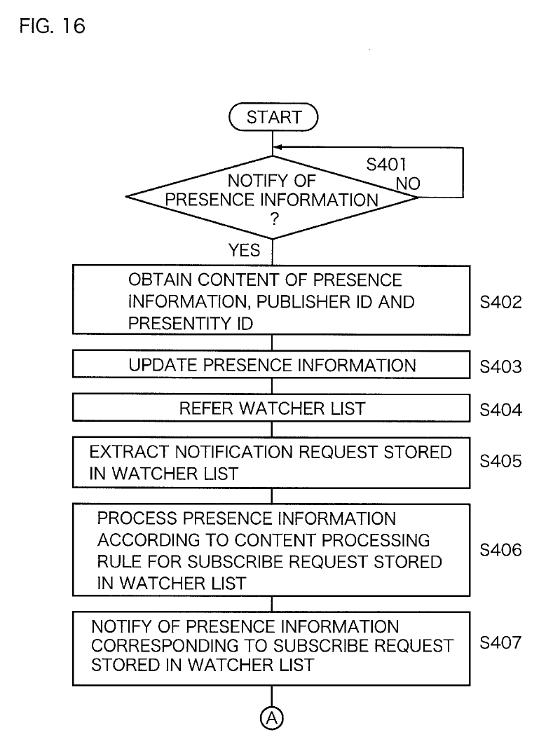

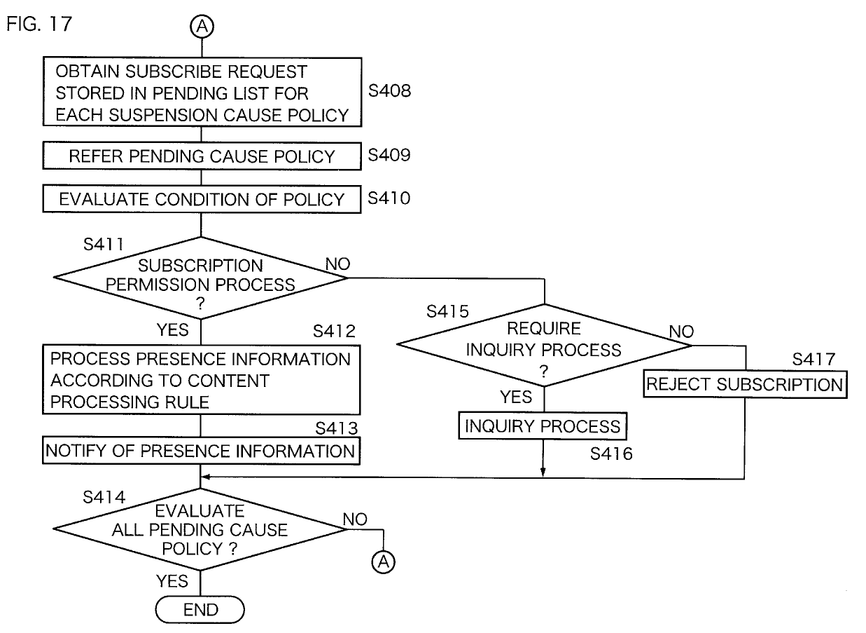

FIGS. 16 and 17 are flow charts illustrating a procedure in which the control unit 10 of the presence server apparatus 1 according to the embodiment determines whether or not the notification is possible or whether or not an inquiry process is required when the presence information is notified.

The control unit 10 of the presence server apparatus 1 determines whether or not the pieces of presence information are notified from the presence terminal apparatuses 2, 2, . . . and 3, 3, . . . (step S401). When the control unit 10 determines that the pieces of presence information are not notified (S401: NO), the control unit 10 returns the process to step S401 and waits until it is determined that the pieces of presence information are notified.

When the control unit 10 determines that the pieces of presence information are notified (S401: YES), contents of the pieces of presence information transmitted from the presence terminal apparatuses 2, 2, . . . and 3, 3, . . . together with a presence update command, a publisher ID, and a presentity ID are acquired (step S402), and the contents of the pieces of presence information in the watcher list are updated (step S403). The control unit 10 refers to the watcher list (step S404) and extracts a subscribe request stored in the watcher list and permitted to be notified (step S405). The control unit 10 processes the contents of the pieces of presence information according to the content processing rule with respect to the extracted the subscribe request (step S406), and notifies of the pieces of presence information to the watcher terminal apparatuses 4, 4, . . . corresponding to the subscribe request stored in the watcher list (step S407).

The control unit 10 acquires the subscribe requests stored in the pending list for every pending cause policy in response to the pieces of presence information received in step S401 (step S408). The control unit 10 refers to the pending cause policy with respect to each of the acquired the subscribe requests (step S409), and evaluates the conditions of the policy based on a watcher ID corresponding to the acquired the subscribe request, the contents of presence information corresponding to the received presence information, a publisher ID, and a presentity ID (step S410). The control unit 10 checks whether or not the subscribe requests are matched with the conditions of the pending cause policy to determine whether or not the process determined to each of the subscribe requests based on the policy is the notification permission (step S411).

When the control unit 10 determines that the determined process is the subscription permission (S411: YES), the control unit 10 processes a content of presence information according to a content processing rule corresponding to a subscribe request determined to be permitted to be subscribed (step S412), and notifies of the processed presence information (step S413).

The control unit 10 determines whether or not the subscribe requests for all pending cause policies stored in the pending list are acquired and evaluated in response to the presence information received in step S401 (step S414). When it is determined that the evaluation for all the suspension cause policies is not performed (S414: NO), the control unit 10 returns the process to step S408 and acquires a subscribe request corresponding to another pending cause policy which is not yet evaluated to execute the processes subsequent to step S408.

When the control unit 10 determines that the evaluation for all the pending cause policies is performed in step S414 (S414: YES), the control unit 10 ends the process of determining whether or not the received presence information can be notified.

When the control unit 10 determines in step S411 that the determined process is not the subscription permission (S411: NO), the control unit 10 determines whether or not an inquiry process whether or not the subscription is permitted is required (step S415). When the control unit 10 determines that the inquiry process whether or not the subscription is permitted is required (S415: YES), the control unit 10 executes the inquiry process whether or not the subscription is permitted to the subscribe request determined to require the inquiry process (step S416) and executes the determining process in step S414. When the control unit 10 determines that evaluation for all the pending cause policies is performed (S414: YES), the control unit 10 ends the process.

When the control unit 10 determines that the inquiry process whether or not the subscription is permitted is not required (S415: NO), the determined process is the notification rejection. Thus, the control unit 10 rejects the subscription (step S417) and executes the determining process in step S414. When the evaluation for all the pending cause policies is performed (S414: YES), the control unit 10 ends the process.

By the above procedure, with respect to the subscribe requests the determinations of which are pending at the time when the subscribe requests are received from the watcher terminal apparatuses 4, 4, . . . , determination whether or not the subscription is permitted is executed when the pieces of presence information are notified. In this manner, by also using, as elements for determination, pieces of information such as a content of actually notified presence information, attribute information of an object, and an ID of a publisher which issues the presence information which cannot be determined when the subscribe request is received, it can be flexibly determined whether or not the subscription is permitted.

In the present invention, since the process is also determined based on the exception list to which the policy is not applied, with respect to a specific the notification request of the notification requests the processes of which cannot be determined when the subscribe requests are received and which are pending, determination can be efficiently performed without pending the determination whether or not the subscription is permitted.

The control unit 10 of the presence server apparatus 1 acquires the subscribe requests for every pending cause policy in step S408 and determines whether or not the subscribe requests are matched with the application conditions of the pending cause policy. Therefore, results evaluated in step S410 may change depending on the subscribe requests. In this case, the processes in step S411 to step S417 are executed with respect to the subscribe requests.

One concrete example about the above processes will be explained such that a case where the object 6 having the presentity ID “DPCα00004” is detected by the sensor 5 having a publisher ID “A1” is applied.

In this case, the presentity ID “DPCα00004” of the object 6 the presence of which is detected by the sensor 5 and the publisher ID “A1” of the sensor 5 itself are transmitted from the sensor 5 to the presence terminal apparatus 3. The control unit 30 of the presence terminal apparatus 3 receiving these IDs execute the procedure shown in the flow chart in FIG. 15 to transmit the publisher ID “A1”, the presentity ID “DPCα00004”, and a content “arrival at receiving gate” of the presence information to the presence server apparatus 1.

The control unit 10 of the presence server apparatus 1 execute the procedures shown in the flow charts in FIG. 16 and FIG. 17 such that the presence information of the object 6 having the presentity ID “DPCα00004” are sent from the presence terminal apparatuses 3, 3, . . . . In this case, by the process in step S403 of the control unit 10 of the presence server apparatus 1, the content of the latest presence information of the object 6 having the presentity ID “DPCα00004” included in the watcher list is updated into “arrival at receiving gate”. The watcher ID “User1” is stored in the watcher list as a permitted the notification destination. Therefore, it is determined by the processes in step S404 to step S407 performed by the control unit 10 that the subscription is permitted, and, according to the content processing rule, the presence information of “arrival at receiving gate” is directly notified to the watcher terminal apparatus 4 used by a user having the watcher ID “User1”.

On the other hand, by the process in step S408, it is determined whether or not a subscribe request which targets the object 6 having the presentity ID “DPCα00004” is stored in the pending list, and, with respect to the subscribe request stored in the pending list, the pending cause policy is evaluated again based on the publisher ID “A1” and the content “arrival at receiving gate” of the presence information (S410). As shown in the content in FIG. 14, three the notification contents related to the object 6 having the presentity ID “DPCα00004” are stored. A matching condition of the policy having the policy ID “policy4” which is one of the pending cause policies of the subscribe requests stored in the pending list is “with respect to a subscribe request from a user of company B, inquiry whether or not pieces of presence information except for the pieces of presence information issued from the publisher ID “A1” and “A3” are permitted is performed to an administrator having an ID “User A”. In this case, since the publisher ID is “A1”, the subscribe request is not matched with the application condition of “policy4”. Therefore, the inquiry process about the watcher IDs “User 2” and “User 4” is not executed, and the presence information is notified. At this time, the watcher IDs “User 2” and “User 4” are IDs of users belonging to company B. Since the content processing rule is not applied to the subscription performed when the publisher ID is “A1”, the content “arrival at receiving gate” of the presence information is notified without being changed.

Another concrete example will be explained such that a case where the object 6 having the presentity ID “DPCα00004” is detected by the sensor 5 having the publisher ID “A2” is applied. In this case, the publisher ID “A2”, the presentity ID “DPCα00004”, and a content “start of test step” of the presence information are transmitted.

Similarly, the processes of the control unit 10 of the presence server apparatus 1 shown in the flow charts in FIG. 16 and FIG. 17 are executed, the presence information “start of test step” is directly notified to the watcher terminal apparatus 4 used by the user having the watcher ID “User 1” permitted to be notified. The pending cause policy is evaluated with reference to the pending list. However, in this case, since the publisher ID is “A2”, the application condition of the pending cause policy “policy4” of the subscribe requests of the watcher IDs “User2” and “User4” are satisfied. Therefore, in this case, an inquiry process at the presence terminal apparatus 2 used by the administrator having the ID “User A” is executed. At this time, since an inquiry process is executed for every pending cause policy the inquiry processes about “User2” and “User4” are collectively executed.

An inquiry process executed by the presence server apparatus 1 in response to a subscribe request determined to require inquiry as a result of evaluation for the conditions of the pending cause policy will be described below.

The control unit 10 of the presence server apparatus 1, with respect to the subscribe request determined to require inquiry, together with an inquiry command, a watcher ID of a notification destination, presentity IDs of the objects 6, 6, . . . serving as the notification targets, and a policy ID of the pending cause policy which is a cause determined to require an inquiry are transmitted to a predetermined terminal apparatus used by an administrator. In Embodiment 1, predetermined terminal apparatuses used by the administrator are presence terminal apparatuses 2, 2, . . . also serving as the watcher terminal apparatuses 4, 4, . . . .

Each of the control units 20 of the presence terminal apparatuses 2, 2, . . . used by the administrator receives an inquiry command, a watcher ID, a presentity ID, and a policy ID transmitted from the presence server apparatus 1. Each of the control units 20 of the presence terminal apparatuses 2, 2, . . . displays an inquiry screen on the display unit 25 based on the received pieces of information. The control unit 20 accepts determination whether or not the subscription is permitted from the administrator.

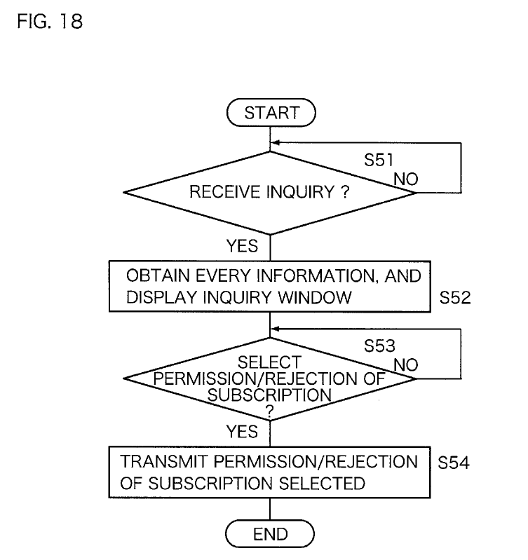

FIG. 18 is a flow chart illustrating a procedure in which the control units 20 of the presence terminal apparatuses 2, 2, . . . according to the embodiment accept determination whether or not the subscription is permitted depending on an inquiry from the presence server apparatus 1.

Each of the control units 20 of the presence terminal apparatuses 2, 2, . . . determines whether or not an inquiry command from the presence server apparatus 1 is received (step S51). When the control unit 20 determines that the inquiry command is not received (S51: NO), the control unit 20 returns the process to step S51 and waits until it is determined that the inquiry command is received.

When the control unit 20 determines that the inquiry command is received (S51: YES), the control unit 20 acquires various pieces of information such as a watcher ID, a presentity ID, and a policy ID which are transmitted together with the inquiry command, and displays an inquiry screen having an input unit for selection of permission or rejection of the subscription on the display unit 25 based on the various pieces of information (step S52).

When an administrator performs an input operation to the input unit for selection on the inquiry screen, the control unit 20 determines whether or not permission or rejection of the subscription is selected (step S53). When the control unit 20 determines that both the permission and the rejection are not selected (step S53: NO), the control unit 20 returns the process to step S53 and waits until it is determined that the permission or the rejection is selected.

When the control unit 20 determines that any one of the permission and the rejection of the subscription is selected (S53: YES), the control unit 20 transmits a result of the selected permission or rejection of the subscription to the presence server apparatus 1 (step S54), and the process of accepting determination whether or not the subscription is permitted in response to an inquiry is ended. When the result of selected permission or rejection of the subscription is to be transmitted in step S54, the control unit 20 transmits the result together with the watcher ID, the presentity ID, and the ID of the policy which is a cause of the inquiry process. In this manner, the control unit 10 of the presence server apparatus 1 can specify a watcher ID for which the result of the determination whether or not the presence information can be notified is obtained and an object 6 from which the result of the determination whether or not the presence information can be notified is obtained.

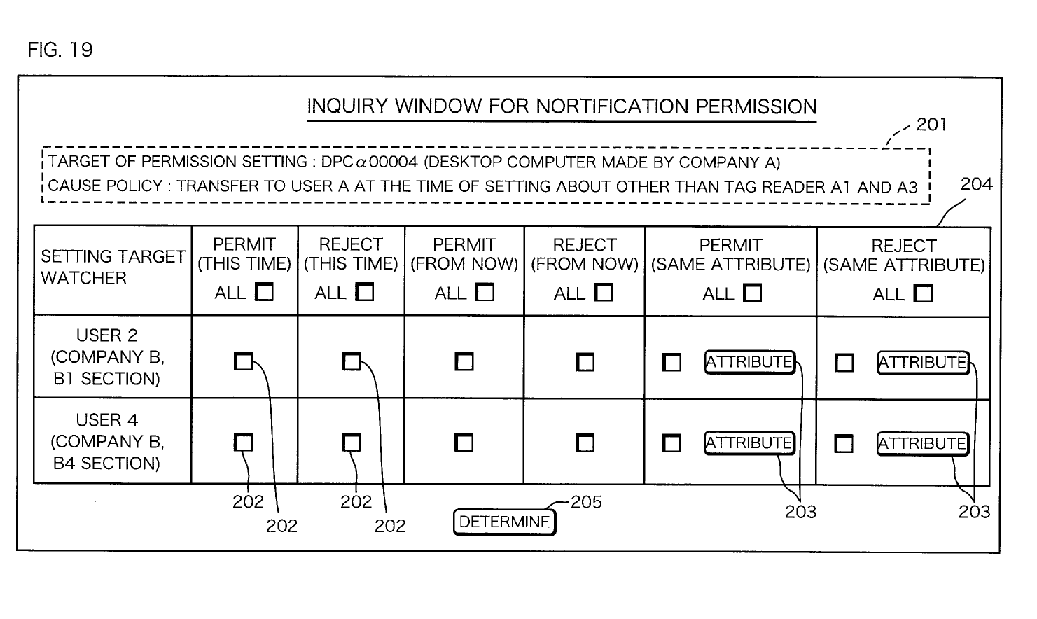

FIG. 19 is an example diagram illustrating a content of an inquiry screen displayed on the display unit 25 of the presence terminal apparatus 2 according to the embodiment. The screen shown in the example diagram in FIG. 19 is displayed on the display unit 25 by the control unit 20 when the control unit 20 of the presence terminal apparatus 2 receives an inquiry command.

The screen shown in the example diagram in FIG. 19 is configured by an information display area 201 displayed based on the presentity ID and the policy ID received by the control unit 20, a permission/rejection selection setting table 204 including check boxes 202, 202, . . . which accept selection of permission/rejection of the subscription and “attribute” buttons 203, 203, . . . , and a “determination” button 205 to transmit a selected and set permission/rejection determination result to the presence server apparatus 1.

In the information display area 201, the objects 6, 6, . . . serving as objects to which determination whether or not the subscription is permitted is performed and information of the policy which is a cause of execution of the inquiry process are displayed. The administrator grasps the information displayed in the information display area 201 and can select permission or rejection of the subscription on the permission/rejection selection setting table 204 with respect to each of users requesting the pieces of presence information of the objects 6, 6, . . . to be notified. The check boxes 202, 202, . . . are configured to be able to be exclusively selected in response to options, i.e., “permission at this time”, “rejection at this time”, “permission from now”, “rejection from now”, “the same attribute is also permitted”, and “the same attribute is also rejected” for every watcher ID. “The same attribute is also permitted” and “the same attribute is also rejected” are options to omit a subsequent inquiry process by selecting “permission from now” or “rejection from now” with respect to the objects 6, 6, . . . having the same attribute except for the objects 6, 6, . . . serving as objects to which determination whether or not the notification is permitted is performed at this time.

Furthermore, a check box 202 in which not only the watcher IDs but also all the watcher IDs can be collectively selected is arranged. In this manner, an administrator can collectively select the permission or the rejection of the subscription.

The “attribute” buttons 203, 203, . . . in the permission/rejection selection setting table are buttons to designate the “attribute”, when the objects 6, 6, . . . having the same attribute as that of the objects 6, 6, . . . serving as objects to which determination whether or not the subscription is permitted is performed are set to be able to be notified collectively.

When the control unit 20 detects that the determination button 205 is depressed, the control unit 20 detects checking states of the check boxes 202, 202, . . . to make it possible to recognize that any of the permission and the rejection of the subscription is selected. When the control unit 20 detects that the determination button 205 is depressed, the control unit 20 transmits, together with a subscription permission/rejection update command representing that the permission or the reject of the subscription is selected, watcher IDs to which the permission or the rejection of the subscription is set, permission/rejection information representing the permission or the rejection of the subscription selected in response to the watcher IDs, and a policy ID serving as a cause of an inquiry process to the presence server apparatus 1. When “the same attribute is also permitted” or “the same attribute is also rejected” is selected, the control unit 10 of the presence server apparatus 1 transmits designated attribute information to the presence server apparatus 1.

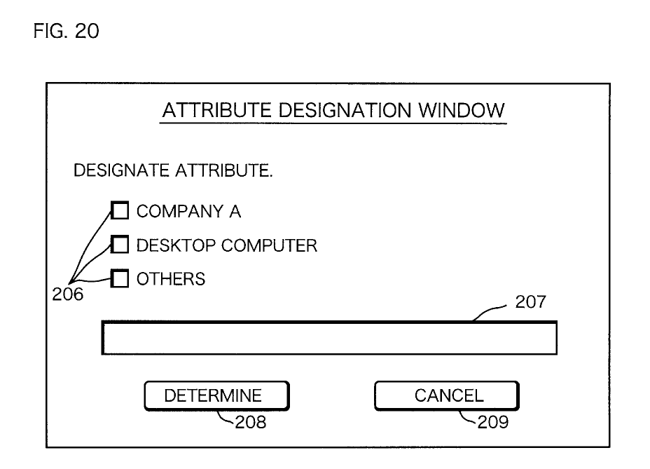

FIG. 20 is an example diagram illustrating a screen displayed on the display unit 25 of the presence terminal apparatus 2 according to the embodiment. The screen shown in the example diagram in FIG. 20 is a screen to designate an attribute displayed when the control unit 20 detects that the “attribute” button on the screen in FIG. 19 is depressed by the input unit 23.

As shown in FIG. 20, in the display unit 25, a list of attributes of the objects 6, 6, . . . serving as objects to which determination whether or not the notification is permitted is performed is displayed so that check boxes 206, 206, . . . can check. In the screen in FIG. 20, two attributes “company A” and “desktop personal computer” are displayed. An edit box 207 in which an attribute which is not included in the list can be input is displayed. An administrator checks the check box 206 of “the other” to make it possible to input an arbitrary attribute name in the edit box 207. The administrator checks any one of the check boxes 206 or inputs the attribute name in the edit box 207. A “determination” button 208 is a button to fix the checked attribute or the input attribute name. When the control unit 20 detects that the “determination” button 208 is depressed, the control unit 20 acquires the checked or input attribute name. When a “cancel” button 209 is depressed, the control unit 20 does not acquire anything to close the screen.

In the present invention, as shown in the example diagram in FIG. 19, with respect to a plurality of the subscribe requests corresponding to one pending cause policy, selections can be collectively accepted. This is because, as shown in the flow charts shown in FIG. 16 and FIG. 17, it is determined whether or not, for every pending cause policy, an inquiry process for a determination whether or not the subscription is permitted to a subscribe request is required to transmit the subscribe requests collectively requesting the inquiry process. In this manner, since the administrator can determine whether or not the subscribe requests from a plurality of users corresponding to the same pending cause with respect to the same object 6 can be collectively notified, the determination can be efficiently performed. In comparison with the case where the inquiry process is performed at each arbitrary time with respect to the same object 6, the possibility that a determination whether or not the subscription is permitted is reduced, and an appropriate determination can be performed, so that a beneficial effect can be obtained. In particular, as in the embodiment, when the objects 6, 6, . . . have various types and are large in number, the determinations whether or not the subscription is possible can be collectively performed with respect to the objects 6, 6, . . . having the same attribute. Therefore, operating efficiency of the administrator can be improved.

As another configuration, a user who is a watcher may select that the subscription to the watcher terminal apparatuses 4, 4, . . . having the same attribute, for example, used by users belonging to the same organization is permitted/rejected.

As described above, a process executed in the presence server apparatus 1 when a determination result of the selected permission/rejection of the subscription is transmitted from the presence terminal apparatus 2 used by the administrator to the presence server apparatus 1 will be described below.

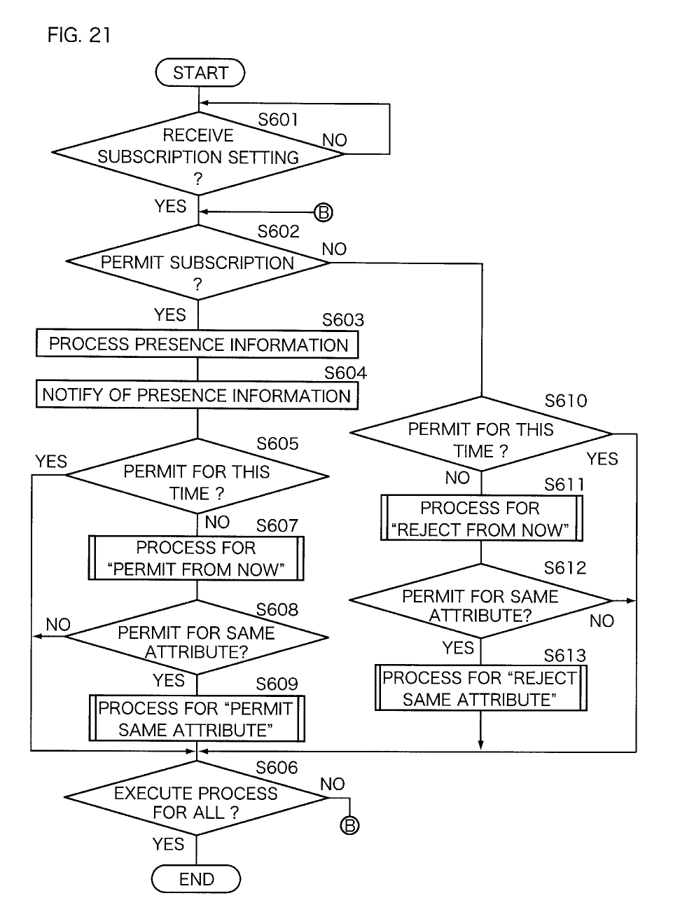

FIG. 21 is a flow chart illustrating an overall outline of a procedure executed by the control unit 10 of the presence server apparatus 1 according to the embodiment based on selected permission/rejection of the subscription.

The control unit 10 of the presence server apparatus 1 determines whether or not a subscription permission/rejection update command transmitted from the presence terminal apparatus 2 used by an administrator is received (step S601). When the control unit 10 determines that the subscription permission/rejection update command is not received (S601: NO), the control unit 10 returns the process to step S601 and waits until that it is determined that the subscription permission/rejection update command is received.

When the control unit 10 determines that the subscription permission/rejection update command is received (S601: YES), the control unit 10 reads permission/rejection information transmitted together with the command for each of watchers to which permission/rejection of the subscription is set, depending on whether or not the result is “permission in this time”, “permission from now”, or “the same attribute is also permitted”, the control unit 10 determines whether or not the subscription to the user of the corresponding watcher ID is permitted (step S602). When the control unit 10 determines the subscription is permitted (S602: YES), according to a content processing rule applied to the watcher ID, a content of an actual presence information, the control unit 10 processes presence information updated in the watcher list (step S603). The control unit 10 notifies of the processed presence information to the watcher terminal apparatuses 4, 4, . . . used by the user having the permitted watcher ID.

The control unit 10 determines whether or not the selected permission/rejection of the subscription is “permission at this time” (step S605). When the control unit 10 determines that the selected permission/rejection of the subscription is “permission at this time” (S605: YES), the control unit 10 determines whether or not the process is executed to all the determination results of permission/rejection of the subscription received together with the subscription permission/rejection update command in step S601 (step S606).

When the permission/rejection of the subscription is “permission at this time”, although the subscription is temporarily permitted, the determination is still pending. Thereafter, even though the presence information of the same object 6 is notified, a subscribe request for which “permission at this time” as the determination result of permission/rejection of the subscription is to be stored in the pending list, and an inquiry process for the determination whether or not the subscription is permitted is performed again.

On the other hand, when the control unit 10 determines that the selected permission/rejection of the subscription is not “permission at this time” (S605: NO), the control unit 10 executes a process corresponding to “permission from now” (step S607), and, furthermore, determines whether or not the selected permission/rejection of the subscription is “the same attribute is also permitted” (step S608).

When the control unit 10 determines that the selected permission/rejection of the subscription is not “the same attribute is also permitted” (S608: NO), the control unit 10 advances the process to the determination process in step S606.

When the control unit 10 determines that the selected permission/rejection of the subscription is “the same attribute is also permitted” (S608: YES), the control unit 10 execute a process corresponding to “the same attribute is also permitted” (step S609) and advances the process to the determination process in step S606.

When the control unit 10 determines in step S602 that the subscription is not permitted, i.e., that the permission/rejection of the subscription is not any one of “permission at this time”, “permission from now”, and “the same attribute is also permitted” (S602: NO), the subscription is rejected. Therefore, furthermore, the control unit 10 determines whether or not the selected permission/rejection is “rejection at this time” (step S610).

When the control unit 10 determines that the selected permission/rejection of the subscription is “rejection at this time” (S610: YES), the control unit 10 directly advances the process to the determination process in step S606. When a process about all permission/rejection of the subscription is not executed, a process corresponding to permission/rejection of the subscription of another the notification request is executed. In this case, as in “permission at this time”, the subscription is temporarily rejected, and the determination is still pending. Thus, the storage of the subscribe request is held in the pending list.

On the other hand, when the control unit 10 determines that the selected permission/rejection of the subscription is not “rejection at this time” (S610: NO), the control unit 10 executes a process corresponding to “rejection from now” (step S611), and, furthermore, determines whether or not the selected permission/rejection is “the same attribute is also rejected” (step S612).

When the control unit 10 determines that the selected permission/rejection of the subscription is not “the same attribute is also rejected” (S612: NO), the control unit 10 advances the process to the determination process in step S606.

When the control unit 10 determines that the selected permission/rejection of the subscription is “the same attribute is also rejected” (S612: YES), the control unit 10 executes a process corresponding to “the same attribute is also rejected” (step S613), the control unit 10 advances the process to the determination process in step S606.

When the control unit 10 determines in step S606 that the process about the determination results of all the permission/rejection of the subscription is not executed (S606: NO), the control unit 10 returns the process to step S602 to execute processes subsequent to step S602 with respect to a determination result of another permission/rejection of the subscription, i.e., permission/rejection information for another the subscription request. On the other hand, when the control unit 10 determines that the process about the determination results of all the permission/rejection of the subscription is executed (S606: YES), the control unit 10 ends the process.

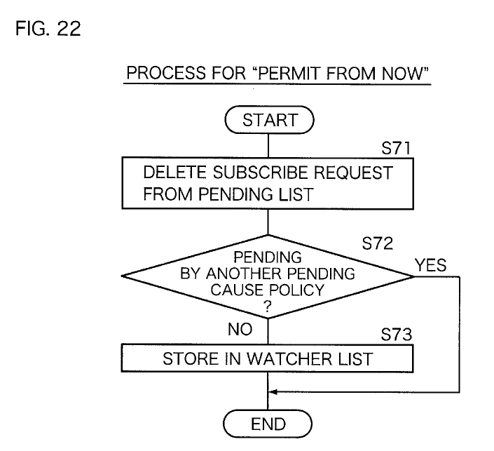

A process corresponding to each selected permission/rejection of the subscription will be described below. FIG. 22 is a flow chart illustrating a procedure executed by the control unit 10 of the presence server apparatus 1 according to the embodiment when permission/rejection of the subscription selected by an inquiry process is “permission from now”. The procedure shown in the flow chart in FIG. 22 is a procedure of a process corresponding to “permission from now” in step S607 in the procedure shown in the flow chart in FIG. 21.

The control unit 10 of the presence server apparatus 1 deletes a subscribe request which permitted to be notified from the pending list (step S71). The control unit 10 determines, with reference to the pending list, whether or not the subscribe request is pending in another pending cause policy (step S72). When the control unit 10 determines that the subscribe request is pending the other pending cause policy (S72: YES), the control unit 10 ends the process corresponding to “permission from now” and returns the process to step S608 shown in the flow chart in FIG. 21.

When the control unit 10 determines that the subscribe request is not pending in the other pending cause policy (S72: NO), the subscribe request is permitted from now. The control unit 10 stores the subscribe request in the watcher list (step S73), ends the process corresponding to “permission from now”, and returns the process to step S608 shown in the flow chart in FIG. 21.

By this process, the subscribe request which selects “permission from now” as permission/rejection of the subscription is stored in the watcher list. Therefore, unless the subscribe request is pending in the other pending cause policy, presence information is notified, and the presence information is notified at the time when the watcher list is referred to.

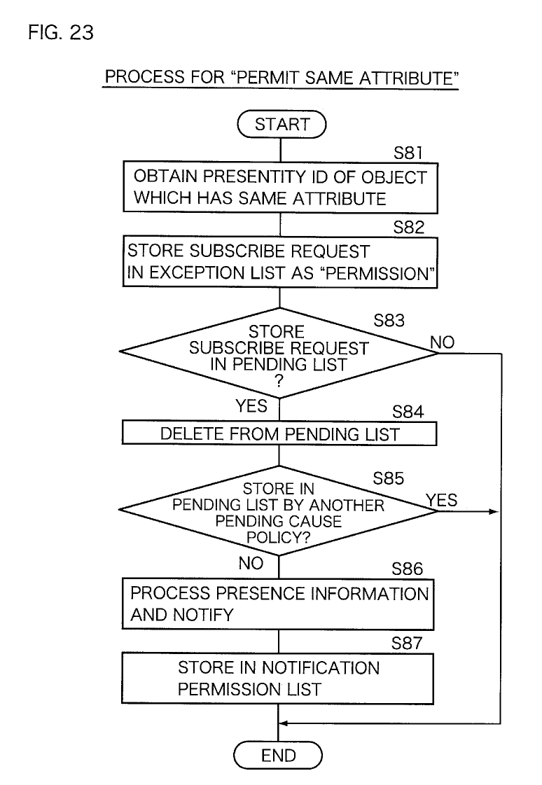

FIG. 23 is a flow chart illustrating a procedure executed by the control unit 10 of the presence server apparatus 1 according to the embodiment when projection/rejection of the subscription selected by an inquiry process is “the same attribute is also permitted”. The procedure shown in the flow chart in FIG. 23 is a procedure of a process corresponding to “permission from now” in step S609 in the procedure shown in the flow chart in FIG. 21.

The control unit 10 of the presence server apparatus 1 acquires the presentity ID of the other objects 6, 6, . . . having the same attribute as that of the object 6 serving as an object to which determination whether or not the subscription is permitted is performed (step S81). When “the same attribute is also permitted” is selected, attribute information designated together with the subscription permission/rejection update command is transmitted from the presence terminal apparatus 2. For this reason, the control unit 10 of the presence server apparatus 1, in step S81, acquires the presentity ID of the other objects 6, 6, . . . having the same attribute based on the transmitted attribute information.

The control unit 10, with respect to the objects 6, 6, . . . having the acquired presentity ID, continuously permits the subscription to the subscribe request from a user of the same watcher ID. Thus, the control unit 10 stores the subscribe request as a subscribe request which is “permitted” in the exception list together with a flag “permission” (step S82).

The control unit 10 determines whether or not, with respect to the objects 6, 6, . . . of the acquired presentity ID, a subscribe request from the user of the same watcher ID is stored in the pending list by the same pending cause policy (step S83). When the subscribe request is transmitted in advance with respect to the objects 6, 6, . . . having the same attribute, the same pending cause policy is matched with the subscribe request, and the subscribe request is probably stored in the pending list. When the control unit 10 determines that the pending request is not stored in the pending list by the same pending cause policy (S83: NO), a subscribe request corresponding to the same pending cause policy with respect to the objects 6, 6, . . . having the same attribute is not transmitted. Thus, the control unit 10 ends the process corresponding to “the same attribute is also permitted” and returns the process to step S606 shown in the flow chart in FIG. 21.

When the control unit 10 determines in step S83 that the subscribe request is stored in the pending list by the same pending cause policy (S83: YES), the stored the subscribe request is deleted from the pending list (step S84).

Furthermore, the control unit 10 determines whether or not a subscribe request from the same user for the objects 6, 6, . . . having the presentity ID acquired in step S81 is stored in the pending list by another pending cause policy (step S85). When the control unit 10 determines that the subscribe request is stored in the pending list by the other pending cause policy (S85: YES), the subscribe request is transmitted with respect to the objects 6, 6, . . . having the same attribute. However, the subscribe request is pending by the other policy and it cannot be determined whether or not the notification is permitted. Therefore, the control unit 10 ends the process corresponding to “the same attribute is also permitted” and returns the process to step S606 shown in the flow chart in FIG. 21.

When the control unit 10 determines that the subscribe request is stored in the pending list by the other pending cause policy (S85: NO), the control unit 10 processes the presence information depending on the subscribe request transmitted in advance for the objects 6, 6, . . . having the same attribute and subscription the presence information (step S86). Furthermore, since the subscribe request will be permitted in the future, the subscribe request is stored in the watcher list (step S87). The control unit 10 ends the process corresponding to “the same attribute is also permitted” and returns the process to step S606 shown in the flow chart in FIG. 21.

With this process, when “the same attribute is also permitted” is selected as permission/rejection of the subscription, not only the subscribe request to which permission/rejection of the subscription is set but also a subscribe request for the objects 6, 6, . . . which have the same attribute and probably pending by the same pending cause policy are not pending. Furthermore, it need not be determined again whether or not a subscribe request for the objects 6, 6, . . . having the same attribute which are transmitted in advance is notified. Therefore, the administrator can efficiently simultaneously determine whether or not notification requests for the objects 6, 6, . . . having the same attribute from the same user who will have to perform the same determination are notified. Since permission/rejection operations of the subscription for the objects 6, 6, . . . having the same attribute can be collectively performed, a probability of error in a determination whether or not the subscription is permitted is reduced, and an appropriate determination can be performed.

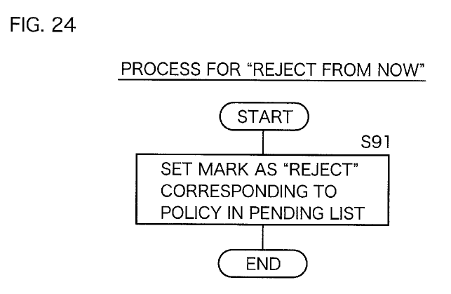

FIG. 24 is a flow chart illustrating a procedure executed by the control unit 10 of the presence server apparatus 1 according to the embodiment when projection/rejection of the subscription selected by an inquiry process is “rejection from now”. The procedure shown in the flow chart in FIG. 24 is a procedure of a process corresponding to “rejection from now” in step S611 in the procedure shown in the flow chart in FIG. 21.

The control unit 10 of the presence server apparatus 1 sets “rejection” as a mark representing permission/rejection of application of a policy corresponding to a subscribe request to which permission/rejection of the subscription is set, the mark being stored in the pending list (step S91), ends the process corresponding to “rejection from now”, and returns the process to step S612 shown in the flow chart in FIG. 21.

With this process, afterward, the subscribe request for which “rejection from now” is selected is not an object to which an inquiry about permission/rejection is executed. In this manner, when presence information of the object 6 serving as an object of the subscribe request is notified from the presence terminal apparatus 2, an inquiry process whether or not the subscription is permitted is not executed by the same policy. Furthermore, even though the subscription is permitted because the subscribe request is matched with a condition of another policy, a subscribe request matched with the policy having the policy ID “policy4” is rejected.

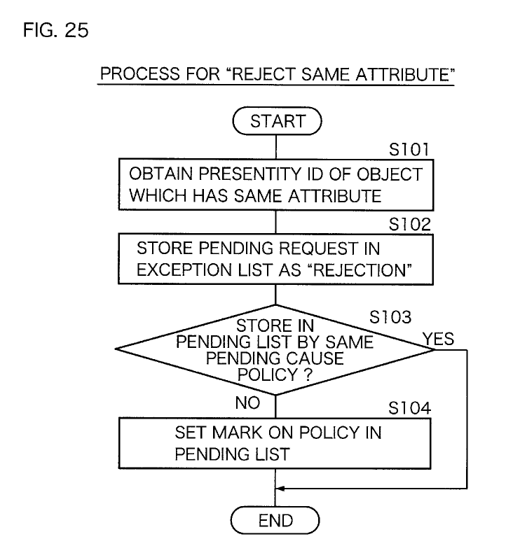

FIG. 25 is a flow chart illustrating a procedure executed by the control unit 10 of the presence server apparatus 1 according to the embodiment when projection/rejection of the subscription selected by an inquiry process is “the same attribute is also rejected”. The procedure shown in the flow chart in FIG. 25 is a procedure of a process corresponding to “the same attribute is also rejected” in step S613 in the procedure shown in the flow chart in FIG. 21.

The control unit 10 of the presence server apparatus 1 acquires the presentity ID of the other objects 6, 6, . . . having the same attribute as that of the object 6 serving as an object to which determination whether or not the subscription is permitted is performed (step S101). When “the same attribute is also rejected”, attribute information designated together with a subscription permission/rejection update command is transmitted from the presence terminal apparatus 2. Therefore, the control unit 10, in step S101, acquires the presentity ID of the other objects 6, 6, . . . having the same attribute based on the transmitted attribute information.

The control unit 10 stores the watcher ID and the policy ID transmitted together with the subscription permission/rejection update command in association with “rejection” flags in the exception list of the objects 6, 6, . . . having the presentity ID acquired in step S101 (step S102).

The control unit 10 determines whether or not a subscribe request related to the objects 6, 6, . . . having the same attribute of the presentity ID acquired in step S101 is stored in the pending list by the same pending cause policy (step S103). When the subscribe request is transmitted in advance with respect to the objects 6, 6, . . . having the same attribute, the same pending cause policy is applied, and the subscribe request is probably stored in the pending list. When the control unit 10 determines that the subscribe request related to the objects 6, 6, . . . having the same attribute is not stored in the same pending cause policy (S103: NO), a subscribe request for the objects 6, 6, . . . having the same attribute is not transmitted in advance. Thus, the control unit 10 ends the process corresponding to “the same attribute is also rejected” and returns the process to step S606 shown in the flow chart in FIG. 21.

When the control unit 10 determines the subscribe request related to the objects 6, 6, . . . having the same attribute is stored by the same pending cause policy (S103: YES), the control unit 10 sets “rejection” as a mark representing permission/rejection of application of a policy corresponding to a stored the subscribe request, i.e., a subscribe request transmitted in advance for the objects 6, 6, . . . having the same attribute (step S104). The control unit 10 ends the process corresponding to “the same attribute is also rejected” and returns the process to step S606 shown in the flow chart in FIG. 21.

With this process, the notification of the subscribe requests requesting the pieces of presence information of the objects 6, 6, . . . having the same attribute may be pending by the same pending cause policy, and the notification of the subscribe requests can be collectively rejected. With respect to the subscribe request transmitted in advance, stored in the pending list by the same pending cause policy, and related to the objects 6, 6, . . . having the same attribute, even though the presence information of the objects 6 are notified, an inquiry process is not performed, and the subscription is automatically rejected.

A concrete example about the processes described above will be explained such that a case where presence information of the object 6 having the presentity ID “DPCα00004” is issued by the sensor 5 having a publisher ID “A2”, an application condition of the pending cause policy “policy4” of the subscribe requests from uses having the watcher IDs “User2” and “User4” is satisfied, and an inquiry at the presence terminal apparatus 2 used by an administrator having the ID “User A” is transmitted is applied.

On the display unit 25 of the presence terminal apparatus 2 used by the administrator having the ID “User A”, as shown in the example diagram in FIG. 19, a screen is displayed. The administrator having the ID “User A” can select any one of “permission at this time”, “permission from now”, “the same attribute is also permitted”, “rejection from now”, and “the same attribute is also rejected” in response to a subscribe request from the user having the watcher ID “User 2”. The administrator can also select permission/rejection of the subscription in response to a subscribe request from the user having the watcher ID “User4”.

A process performed when “permission at this time” is selected in response to the subscribe request from the user having the watcher ID “User 2” will be concretely explained. In this case, from the presence terminal apparatus 2 used by the administrator having the ID “User A”, together with a subscription permission/reception update command, the watcher ID “User 2”, permission/rejection information (“permission at this time”) of selected permission/rejection of the subscription, and a pending cause policy ID “policy4” are transmitted to the presence server apparatus 1. The control unit 10 of the presence server apparatus 1 execute a procedure shown in the flow chart in FIG. 21. Since the selected permission/rejection of the subscription is “permission at this time”, it is determined in step S602 that the subscription is permitted, a content of the presence information is processed according to a content processing rule, and the presence information is notified to the watcher terminal apparatus 4 used by the user having the watcher ID “User 2”. Since “permission at this time” is selected, the control unit 10 ends the process. At this time, the subscribe request related to the object 6 having the presentity ID “DPCα00004” from the user having the watcher ID “User 2” is still stored in the pending list.

A process performed when “permission from now” is selected in response to the subscribe request from the user having the watcher ID “User 2” will be concretely explained. Information transmitted from the presence terminal apparatus 2 used by the administrator is the same as that transmitted when “permission at this time” is selected. Since the selected permission/rejection of the subscription is “permission from now”, as in the case where “permission at this time” is selected, it is determined in step S602 that the subscription is permitted. The presence information the content of which is processed is notified to the watcher terminal apparatus 4 used by the user having the watcher ID “User 2”.

When “permission from now” is selected, in addition thereto, a procedure shown in the flow chart in FIG. 22 is executed. With the process in step S71, with respect to the object 6 having the presentity ID “DPCα00004”, a subscribe request from the user having the watcher ID “User 2” in which the policy having the policy ID “policy 4” as a pending cause policy is deleted from the pending list. Furthermore, when the subscribe request is not pending by another policy (S72: NO), i.e., when, with respect to the object 6 having the presentity ID “DPCα00004”, the watcher ID “User 2” for a pending cause policy except for the policy having the policy ID “policy 4” is not stored, the watcher ID “User 2” is added to the watcher list of the presentity ID “DPCα00004”. In this manner, even though the presence information of the object 6 having the presentity ID “DPCα00004” is notified, the notification to the watcher terminal apparatus 4 used by the user having the watcher ID “User2” is not pending by the same policy.

A process performed when “the same attribute is also permitted” is selected in response to the subscribe request from the user having the watcher ID “User 2” will be concretely explained. As information transmitted from the presence terminal apparatus 2 used by the administrator, in addition to the case where “permission at this time” is selected, attribute information representing a designated attribute is transmitted. A case where “desktop personal computer available from company α” is designated as an attribute by the administrator having the ID “User A” will be explained as an example.

Even though “the same attribute is also permitted” is selected, the processes in step S603, step S604, step S607 in the procedure shown in the flow chart in FIG. 21 are executed. Therefore, as in the case where “permission from now” is selected, a process of the notification presence information to a subscribe request to which permission/rejection of the subscription is set, a process of deleting from the pending list, and, depending on circumstances, a process of storing in the watcher list are performed.

When “the same attribute is also permitted” is selected, in addition thereto, the procedure shown in the flow chart in FIG. 23 is executed. Since “desktop personal computer available from company a” is designated as the same attribute, “DPCα00001” to “DPCα00003”, “DPCα00005”, “DPCα00006”, . . . having the same attribute as that of the presentity ID “DPCα00004” are acquired. With the process in step S82, a notification request from the user having the watcher ID “User2” requesting the presence information of each acquired “desktop personal computer available from company a” to be notified is stored in the exception list such that the subscription is “permitted” without applying the policy having the policy ID “policy 4”.

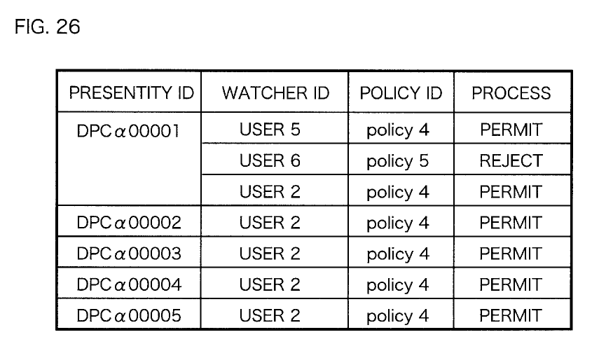

FIG. 26 is an example diagram illustrating an example in which a subscribe request is added to an exception list of the storing unit 11 of the presence server apparatus 1 according to the embodiment. The example diagram in FIG. 26 shows that the subscribe request is added to the exception list in the example diagram in FIG. 9.

In the example diagram in FIG. 26, as described in the above concrete example, the object 6 having the same attribute as that of “desktop personal computer available from company α” is additionally described. More specifically, the watcher ID “User 2” and the policy ID “policy 4” are stored together with the “permission” flag in response to the presentity ID “DPCα00001” to “DPCα00003” and “DPCα00005”.

Furthermore, when the subscribe requests requesting the pieces of presence information of the objects 6, 6, . . . having the same attribute and being pending by the same pending cause policy (ID “policy 4”) are stored in the pending list, these the subscribe requests are deleted from the pending list (S84). For example, when a subscribe request from the user having the watcher ID “User 4” requesting the presence information of the object 6 having the presentity ID “DPCα00005” of the same attribute to be notified is stored in the pending list by using the policy having the policy ID “policy4” as the pending cause policy, the subscribe request is deleted.

Furthermore, when the subscribe request deleted from the pending list by the process in step S84 is not pending by a policy except for the policy ID “policy4”, the notification of the presence information is executed to each of the subscribe requests, and the subscribe request is additionally described in the watcher list such that the notification of the presence information is subsequently permitted.

A process performed when “rejection at this time” is selected in response to a subscribe request from the user having the watcher ID “User 2” will be concretely explained. The control unit 10 of the presence server apparatus 1 executes the procedure shown in the flow chart in FIG. 21. However, in this case, since the subscription is rejected, any process is not performed. At this time, the subscribe request related to the object 6 having the presentity ID “DPCα00004” from the watcher ID “User 2” is still stored in the pending list.

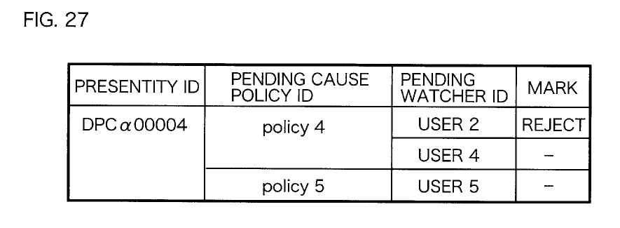

When “rejection from now” is selected, the procedure shown in the flow chart in FIG. 24 is executed. In this case, from the presence terminal apparatus 2 used by the administrator, together with the subscription permission/rejection update command, the watcher ID “User 2”, permission/rejection information (“may be rejected from now”) of selected permission/rejection of the subscription, and a pending cause policy ID “policy4” are transmitted to the presence server apparatus 1. With the process in step S91, with respect to the object 6 having the presentity ID “DPCα00004”, with respect to a subscribe request from the user having the watcher ID “User 2” in which the policy having the policy ID “policy 4” as a pending cause policy a mark (“rejection”) representing permission/rejection of application of the policy is stored. FIG. 27 is an example diagram illustrating an example in which a mark is set in the pending list of the storing unit 11 of the presence server apparatus 1 according to the embodiment.

In this manner, even though the presence information of the object 6 having the presentity ID “DPCα00004” is notified, it is not evaluated whether or not an application condition of the pending cause policy is satisfied with respect to the notification to the watcher terminal apparatus 4 used by the user having the watcher ID “User 2”, and the notification to the user having the watcher ID “User 2” is rejected. Communicating of the presence information of the object 6 having the presentity ID “DPCα00004” to the user having the watcher ID “User 2 is not an object to which an inquiry process is executed subsequently, and the subscribe request is not deleted from the pending list.

A process performed when “the same attribute is also rejected” is selected to the subscribe request from the user having the watcher ID “User 2” will be concretely explained. As information transmitted from the presence terminal apparatus 2 used by the administrator, in addition to the case where “permission from now” is selected, attribute information representing a designated attribute is transmitted. A case where “desktop personal computer available from company α” is designated as an attribute by the administrator having the ID “User A” will be explained as an example.

Even though “the same attribute is also rejected” is selected, the flow chart shown in the flow chart in FIG. 24 (step S622 in the flow chart in FIG. 21) is executed. Therefore, as in the case where “rejection from now” is selected, a mark (“rejection”) representing permission/rejection of application of a policy of a subscribe request which is stored in the pending list and the subscription of which is rejected is set.

When “the same attribute is also rejected” is selected, in addition thereto, the procedure shown in the flow chart in FIG. 25 is executed. Since “desktop personal computer available from company a” is designated as the same attribute, “DPCα00001” to “DPCα00003”, “DPCα00005”, “DPCα00006”, . . . having the same attribute as that of the presentity ID “DPCα00004” are acquired (S10). With the process in step S102, a subscribe request from the user having the watcher ID “User 2” requesting the presence information of each acquired “desktop personal computer available from company α” to be notified is stored in the exception list such that the subscription is “rejected” without applying the policy having the policy ID “policy 4”.

Furthermore, according to the process in step S104, with respect to a subscribe request from the watcher ID “User 2” requesting the presence information of acquired each “desktop personal computer available from company α”, the subscribe request being pending by the policy having the policy ID “policy 4”, a mark (“rejection”) representing permission/rejection of application of the policy is set. In this manner, with respect to the subscribe request corresponding to the same pending cause policy of the object 6 having the same attribute, it need not be repetitively determined whether or not the subscription is permitted, and the process of determining whether or not the subscription is permitted becomes efficient.

In the present invention, as described above, a plurality of options of permission/rejection of the subscription can be selected in the inquiry process, an inquiry whether or not the objects 6 having the same attribute is collectively permitted to notify of information can be performed. When the selected permission/rejection of the subscription is stored by the central apparatus, it can be efficiently determined whether or not the subscription is permitted in subsequent the notification of presence information.

In the embodiment, determination for the subscribe request stored in the pending list is still pending until presence information is updated, the presence information of the object 6 serving as an object requested to which next determination whether or not the subscription is permitted being performed, and an inquiry process is not executed. Therefore, after a predetermined period of time has elapsed since the subscribe request is stored in the pending list, even though presence information is not sent from the presence terminal apparatus 2, the inquiry process may be designed to be performed. While the subscribe request is stored in the pending list, the subscription may be temporarily permitted once, and the presence information may be immediately notified.

The embodiment has the configuration in which the subscribe requests the processes of which cannot be determined with reference to policy information when the subscribe requests are received from the watcher terminal apparatuses 4, 4, . . . are stored in the pending list. However, the present invention may have a configuration in which determination for the subscribe requests simply received from the watcher terminal apparatuses 4, 4, . . . is not performed until presence information is notified.

In the embodiment, as shown in the example diagram in FIG. 19, permission/rejection at this time or permission/rejection from now is made selectable by an inquiry screen to obtain a configuration in which selection can be accepted such that temporary permission/rejection and continuous permission/rejection are sorted. However, the present invention is not limited to this configuration, selection of “permission/rejection” may be simply accepted to obtain a configuration in which only one of selection of temporary permission/rejection and selection of continuous permission/rejection is performed.

In the embodiment, the screens displayed by the watcher terminal apparatus 4 and the presence terminal apparatus 2 are configured to be displayed by reading and executing application programs stored in the storing units of the apparatuses. However, the present invention is not limited to this configuration. These screens may be displayed on a Web browser to obtain a configuration in which the screens are displayed on the basis of information transmitted from the presence server apparatus 1.

The embodiment has the configuration in which the objects 6, 6, . . . (presentities) are things and have the RFID tags 7, 7, . . . attached thereto, and the presence terminal apparatuses 2, 2, . . . and 3, 3, . . . are connected to the sensors 5, 5, . . . (publisher apparatuses) serving as RFID tag readers. However, the present invention is not limited to the configuration. The present invention may have a configuration in which the objects 6, 6, . . . (presentities) are persons who are publishers setting pieces of presence information of the persons, and the presence terminal apparatuses 2, 2, . . . and 3, 3, . . . detect that contents of the pieces of presence information input from the publishers change to transmit the pieces of presence information. In this case, attribute information of the publisher includes an attribute (group or the like to which a person belongs) of a person who is a publisher and a presentity.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification related to a illustrating of the superiority and inferiority of the invention. Although the embodiments of the present inventions have been described in detail, it should be understood that the various changes, substitutions, and alternations could be made hereto without departing from the spirit and scope of the invention.

What is claimed is:

1. An information communication system comprising:
a first terminal apparatus which includes a notifying unit for notifying of presence information including status information of an object,
a second terminal apparatus which includes a transmitting unit for transmitting a subscribe request of the presence information, and
a central apparatus which includes
a relay unit for relaying the first and second terminal apparatuses to each other; and
a control unit capable of performing operations of:
determining whether or not a subscription of presence information by the second terminal apparatus is permitted, when an update of the presence information is received from the first terminal apparatus; and
providing the notification of the presence information to the second terminal apparatus to which the presence information is permitted to be notified.

2. The information communication system according to claim 1, wherein
the central apparatus further comprises a storing unit for storing policy information including a subscription permission condition based on one or at least two of pieces of a content of presence information, attribute information of the object, and attribute information of a publisher which issues presence information of the object; and
the control unit capable of determining whether or not a subscription of presence information by the second terminal apparatus is permitted based on the policy information, when the update of the presence information is received from the first terminal apparatus.

3. The information communication system according to claim 2, wherein the control unit further capable of performing operations of
determining whether or not a process corresponding to the subscribe request based on the policy information can be decided, when the subscribe request is received from the second terminal apparatus;
storing the subscribe request determined not to be decided in a suspension list; and
determining whether or not a subscription of presence information to the second terminal apparatus is permitted based on the policy information, when presence information corresponding to the subscribe request stored in the suspension list is received from the first terminal apparatus.

4. The information communication system according to claim 2, wherein the policy information includes necessity/unnecessity of an inquiry process which transmits an inquiry to a predetermined terminal apparatus about permission/rejection of communicating to the second terminal apparatus, and
the control unit further capable of performing operations of
determining whether or not an inquiry process to the predetermined terminal apparatus is necessary based on the policy information, when a subscribe request is received from the second terminal apparatus;
storing a subscribe request determined to require an inquiry process in a suspension list; and
executing an inquiry process to the predetermined terminal apparatus when presence information corresponding to the subscribe request stored in the suspension list is received from the first terminal apparatus.

5. The information communication system according to claim 4, wherein the control unit capable of executing the inquiry process collectively for the subscribe request stored in the suspension list.

6. The information communication system according to claim 4, wherein the inquiry process accepts any one of a selection of temporary permission/rejection and a selection of continuous permission/rejection in response to the subscribe request from the second terminal apparatus.

7. The information communication system according to claim 6, wherein the control unit capable of performing operations of
storing a subscribe request permitted to notify of presence information of the object for every object in a subscription permission list; and
adding the subscribe request to the subscription permission list in response to the subscribe request in the inquiry process, when the selection of continuous permission is accepted.

8. The information communication system according to claim 6, wherein the control unit capable of storing information to prevent notifications in response to the subscribe request subsequently when the selection of continuous rejection is accepted in response to the subscribe request in the inquiry process.

9. The information communication system according to claim 1, wherein the control unit further capable of determining an attribute of the object; and
the inquiry process accepts a selection of permission/rejection to another subscribe request targeting presence information of an object including the same attribute as that of the object corresponding to the subscribe request in response to a subscribe request from the second terminal apparatus.

10. The information communication system according to claim 1, wherein the control unit capable of executing the inquiry process to the subscribe request, when a predetermined period of time has elapsed since subscribe request is stored in the suspension list.

11. The information communication system according to claim 1, wherein the control unit capable of storing a subscribe request in an exception list in association with permission/rejection of notification, and
a determination based on the permission/rejection stored in the exception list is preferentially performed.

12. The information communication system according to claim 11, wherein
when a selection of continuous permission/rejection to another subscribe request targeting presence information of the object including the same attribute is accepted, the control unit stores the other subscribe request in the exception list together with the accepted selection of permission/rejection.

13. The information communication system according to claim 1, wherein the control unit capable performing operations of
processing a content of the presence information communicated from the first terminal apparatus depending on one or at least two of the content, a communicating destination, an attribute of the object, an attribute of a watcher corresponding to a subscribe request source of the presence information of the object; and
notifying of the presence information including the processed content.

14. The information communication system according to claim 1, wherein
the object includes a communication device which stores and transmits identification information of the object, and
the publisher is configured by a sensor which detects the presence of the communication device, and transmits identification information transmitted from the detected communication device to the first terminal apparatus.

15. An information communication method, using
a first terminal apparatus, a second terminal apparatus, and a central apparatus which is connected to the first and second terminal apparatuses, the information communication method comprising:
transmitting a subscribe request of presence information from the second terminal apparatus;
notifying of presence information including status information of an object from the first terminal apparatus;
determining whether or not the subscription of presence information by the second terminal apparatus is permitted by the central apparatus, when the update of the presence information is received from the first terminal apparatus; and
providing the notification of the presence information to the second terminal apparatus to which the presence information is permitted to be notified.

16. The information communication method according to claim 15, wherein the central apparatus stores policy information including a communicating permission condition of presence information to the second terminal apparatus and necessity/unnecessity of an inquiry process which transmits an inquiry to a predetermined terminal apparatus with respect to permission/rejection of notifying the second terminal apparatus, and
the information communication method comprising:
determining whether or not a decision of a process corresponding to the subscribe request based on the policy information is permitted, when the subscribe request is received from the second terminal apparatus;
storing the subscribe request determined not to be decided in a suspension list; and
determining whether or not the subscription is permitted or whether or not the inquiry process is necessary with reference to the policy information, when the presence information corresponding to the subscribe request stored in the suspension list is notified from the first terminal apparatus.

17. An information communication apparatus comprising:
a receiving unit for receiving presence information including status information of an object;
a notifying unit for notifying of the received presence information to an external apparatus permitted to notify; and
a control unit for determining whether or not communicating to the external apparatus is permitted when the presence information is received.

18. The information communication apparatus according to claim 17, further comprising:
a storing unit for storing policy information including a subscription permission condition of the presence information to the second terminal apparatus and necessity/unnecessity of an inquiry process which transmits an inquiry to a predetermined terminal apparatus with respect to permission/rejection of notifying to the second terminal apparatus; wherein
the control unit capable of performing operations of:
determining whether or not a process corresponding to the subscribe request based on the policy information can be decided, when the subscribe request is received from the second terminal apparatus,
storing the subscribe request determined not to be decided in a suspension list; and
determining whether or not communicating is permitted or whether or not the inquiry process is necessary with reference to the policy information, when presence information corresponding to the subscribe request stored in the suspension list is notified.

19. A recording medium storing a computer program for causing a computer to function as:
receiving presence information notified from a first external apparatus;
determining whether or not the subscription of the presence information by a second external apparatus is permitted, when the update of the presence information is received from the first terminal apparatus; and
providing the notification of the presence information to the second external apparatus to which the presence information is permitted to be notified.

20. The recording medium according to claim 19, the computer program causing the computer to function as:
storing policy information including a subscription permission condition of the presence information to a second external apparatus and necessity/unnecessity of an inquiry process which transmits an inquiry to a predetermined terminal apparatus with respect to permission/rejection of communicating to the second external apparatus;
determining whether or not a process corresponding to the subscribe request based on the policy information can be decided, when the subscribe request is received from the second external apparatus;
storing the subscribe request determined not to be decided in a suspension list; and
determining whether or not the subscription is permitted or whether or not the inquiry process is necessary with reference to the policy information, when the presence information corresponding to the subscribe request stored in the suspension list is notified.
